(19) United States
(12) Patent Application Publication
(10) Pub. No.: US 2024/0252857 A1
(43) Pub. Date: Aug. 1, 2024

(54) WILDFIRE DEFENSE SPRAYING SYSTEM FOR SPRAYING ENVIRONMENTALLY-CLEAN WATER-BASED LIQUID FIRE INHIBITOR TO PROACTIVELY FORM THIN FIRE-INHIBITING ALKALI METAL SALT CRYSTALLINE COATINGS ON SPRAYED PROPERTY SURFACES PRIOR TO THE PRESENCE OF WILDFIRE

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 18/432,014

(22) Filed: Feb. 4, 2024

Related U.S. Application Data
(63) Continuation of application No. 18/329,979, filed on Jun. 6, 2023.
Application No. 18/329,979 is a continuation-in-part of application No. 17/167,084, filed on Feb. 4, 2021, now Pat. No. 11,865,390.
Application No. 17/167,084 is a continuation-in-part of application No. 17/497,948, filed on Oct. 10, 2021, now Pat. No. 11,730,987.

(51) Int. Cl. A62C 3/02; A62C 37/40; A62D 1/00

(52) U.S. Cl. CPC A62C 3/0292; A62C 37/40; A62D 1/0035

(57) ABSTRACT

A wildfire defense spraying system installed on property with combustible property surfaces, and adapted for spraying the combustible property surfaces with an environmentally-clean water-based liquid fire inhibitor for defending against wildfire by inhibiting fire ignition and flame spread caused by hot flying wildfire embers created during a wildfire storm. The wildfire defense spraying system includes: a storage tank containing a supply of environmentally-clean liquid fire inhibitor comprising an alkali metal salt of a nonpolymeric carboxylic acid, and triethyl citrate (TEC) dissolved in water according to a prespecified formulation, wherein the environmentally-clean water-based liquid fire inhibitor remains stable without the formation of solids at expected operating temperatures, and ready for immediate spraying on combustible surfaces. An electric-powered hydraulic pump system is connected to a remote power control switch employed to supply electrical power to the electric-powered hydraulic pump system. A plurality of spray heads are mounted about the property and any buildings thereon, and arranged in fluid communication with the storage tank and the hydraulic pump system. During operation, the hydraulic pump system automatically pumps environmentally-clean water-based liquid fire inhibitor from the storage tank and through the spray heads to generate a spray pattern of environmentally-clean water-based liquid fire inhibitor over all the combustible surfaces on the property. As water molecules in the sprayed environmentally-clean water-based liquid fire inhibitor evaporate to the environment, thin fire-inhibiting alkali metal salt crystalline coatings form on the combustible property surfaces, inhibiting fire ignition and flame spread in the presence of wildfire embers.

### RELATED CASES

The present patent Application is a Continuation of copending U.S. patent application Ser. No. 18/329,979 filed Jun. 6, 2023, which is a Continuation-in-Part of copending: U.S. patent application Ser. No. 17/167,084 filed Feb. 4, 2021; and U.S. patent application Ser. No. 17/497,948 filed Oct. 10, 2021; wherein each said U.S. patent application is commonly owned by Mighty Fire Breaker LLC and incorporated herein by reference as if fully set forth herein.

### BACKGROUND OF INVENTION

### Field of Invention

The present invention is directed towards improvements in science and technology applied in the defense of human and animal life and property, against the ravaging and destructive forces of wildfire.

### Brief Description of the State of Knowledge in the Art

Over the past century, millions of people have developed and settled towns, counties and neighborhoods in regions that today are called the Wildfire Urban Interface (WUI), which are at high risk to wildfires, and this is impacting home owners and property insurance industry. For man to live and survive a sustainable future in the urban-wildfire interface, human society must quickly adapt to survive the destructive effects of wildfires.

Conventional methods of wildfire fighting defense include:
Making firebreaks with bulldozers and shovels, which has not viable in most urbanized communities;
Making firebreaks with backfires has proven ineffective in many cases, and often dangerous as wildfires themselves;
Dropping PhosChek® AMP-based liquid chemical from 5000 feet heights in urban areas, which is dangerous and not viable or effective in wildfire defense;
Thinning forests of dead trees and debris in urban regions, especially near power poles, buildings, and structures.

Current methods of wildfire defense and fighting are becoming unsustainable because the financial losses due to wildfire are exceeding what the insurance industry is willing to insure, as the damage caused by wildfire to the environment is typically catastrophic and destruction.

For several decades now, wildfire defense methods have proposed proactively spraying homes, buildings and properties with chemical fire retardants—to defend against hot wildfire embers flying in the direction of prevailing winds, in search of combustible fuel.

In 2006, US Patent Application Publication No. 2006/0113403A1 (Aamodt of Firebreak Spray Systems LLC) disclosed a fire-retardant distribution system designed for use with any type of structure such as residences, out buildings, barns, commercial buildings, and others. This prior art system is designed to prevent structures from catching fire when a wildfire approaches, and relies upon a spray system that when activated coats the exterior of the structures, decks, and surrounding landscape very rapidly with a liquid, decolorized fire retardant that remains on the surface until washed off. The system is self-contained and relies upon tanks pressurized with inert gas to deliver the fire retardant to spray valves positioned on and around the structures and surrounding areas. In an alternate embodiment, compressed gas-powered pumps deliver fire retardant to desired areas to flank a wildfire and control its direction and behavior. In general, such firebreak spray systems are expense to install and use liquid fire retardants that are less than optimal from performance criteria, as well as from an environmental sustainability perspective.

Wildfire defense methods have also proposed the use of hydrogels as disclosed in U.S. Pat. Nos. 3,229,769 and 5,849,210, for the purpose of cooling the source of the fire by retaining water close to the flame. In general, such hydrogels are produced from a water-absorbing polymer and water. The hydrogel binds the water and so stops the water from flowing away from the source of the fire. Because hydrogels can maintain a large amount of water near the fire, hydrogels have a good immediate extinguishing effect. In contrast, the long-term effect of hydrogels is poor. Hydrogels can dry and thereby rapidly lose their effect. The remaining salt-like dried hydrogels have a very low fire-retarding effect.

U.S. Pat. No. 8,273,813 (assigned to BASF) also proposes combining water-absorbing polymers with fire-retarding salts to form fire-retarding compositions having a good immediate extinguishing effect and a good long-term effect, but are not ideal for use in automated firebreak spraying systems discussed above.

For over a decade, Hartindo's anti-fire (AF) chemical solution AF31 has been used in proactive fire defense applications including wildfire defense. While AF31 solution employs tripotassium citrate dissolved in water with minor amounts of a natural gum added to provide cling, the natural gum tends to clog spray nozzles requiring additional cleaning and maintenance, and adversely impacts many species of plant life including flowing plants, tender perennials and vegetables.

Clearly, there is a great need in the art for better, more effective, and less expensive ways of and means for proactively defending property parcels, houses and buildings constructed thereon, from the threat of fire ignition and flame spread caused by hot wind-driven wildfire embers associated with wildfires.

### OBJECTS AND SUMMARY OF THE PRESENT INVENTION

Accordingly, a primary object of the present is to provide new and improved home wildfire defense spraying system installation kit, and method of installing and operating the same on a parcel of property, for proactively spraying environmentally-clean liquid fire inhibitor on the property to inhibit fire ignition and flame spread caused by hot wind-driven wildfire embers, while overcoming the shortcomings and drawbacks of prior art methods and apparatus.

Another object of the present invention is to provide such a wildfire defense spraying system installation kit, wherein environmentally-clean wildfire inhibiting biochemical compositions in dry powder phase are pre-mixed and loaded in the storage tank of the spraying system, and ready for the addition of a proper quantity of water at the time of system installation and activation, to thereby formulate a high-performance liquid chemical fire inhibitor at the installation site in a simple and reliable manner, so that the system can automatically spray the liquid chemistry over combustible ground surfaces, native ground fuel, living plants, trees and shrubs, and when dried, forms thin potassium salt crystalline coatings having improved surface coverage and providing excellent inhibition to fire ignition, flame spread, and smoke development in the presence of wildfire.

Another object of the present invention is to provide a new and improved wildfire defense spraying system for spraying an environmentally-clean wildfire inhibitor liquid biochemical solution that is formulated at the system installation site by (i) dissolving in a predetermined quantity of water, a first quantity of dry powder tripotassium citrate (TPC) functioning as a fire inhibitor with a second quantity of liquid triethyl citrate (TEC) functioning as a coalescent agent, wherein both first and second quantities are preloaded in a liquid storage tank connected to an electric battery-powered spray pump, so as to form a clear wildfire inhibitor solution which, after sprayed over combustible surfaces to be protected against wildfire, (ii) allows potassium cations dissolved in the solution to disperse and participate in the formation thin potassium citrate salt crystalline coatings on treated surfaces and function as optically-transparent wildfire inhibitor coatings, which once dried, can reabsorb water at the surface without rapid dissolution to improve the duration of fire protection offered by the wildfire inhibitor composition in the presence of rain and ambient moisture levels.

Another object of the present invention is to provide a kit of apparatus for installing a home wildfire defense for installation on a home property so that it can be triggered to spray a new and improved wildfire inhibitor liquid having a coalescent agent that promotes the formation of thin potassium salt crystalline coatings deposited onto organic fuel surfaces to be protected against the threat of ignition by wildfire, providing optimized methods of wildfire inhibitor deposition in outdoor environments.

Another object of the present invention is to provide a new and improved fire inhibiting biochemical composition kit comprising: a major amount of dry tripotassium citrate (TPC), and a minor amount of triethyl citrate (TEC), as components for mixing with a predetermined major amount of water functioning as a solvent, carrier and dispersant, to make up a predetermined quantity of environmentally-clean liquid fire inhibiting biochemical composition for proactively protecting combustible property and wood products.

Another object of the present invention is to provide a new and improved home wildfire defense spraying system for installation on a property to be protected against wildfire, and automatically triggered to spray an environmentally-clean aqueous-based fire inhibiting liquid biochemical solution on the property when receiving a radio signal transmitted by smartphone operating over a 4G GSM digital cellular communication network.

Another object of the present invention is to provide a new and improved system installation kit that contains all of the components and instructions required for any home owner or contractor to quickly and affordably install and support a wildfire defense spraying system on a specified parcel of property so that, prior to arrival of a wildfire, the home owner can remotely command the proactive spraying of their property with a clean and sustainable liquid fire inhibitor stored in a liquid storage tank.

Another object of the present invention is to provide such a wildfire defense spraying system installed on a specified parcel of property, wherein the liquid fire inhibitor stored in the storage tank comprises: (a) a dispersing agent realized in the form of a quantity of water, for dispersing metal ions dissolved in the water; (b) fire inhibiting agent realized in the form of tripotassium citrate, for providing metal potassium ions dispersed in the water when tripotassium citrate is dissolved in the water; and (c) a coalescing agent realized the form of triethyl citrate, an ester of citric acid, for dispersing and coalescing the potassium ions when the fire inhibiting liquid composition is applied to a surface to be protected against fire, and while water molecules in the water evaporate during drying, the potassium ions cooperate to form thin potassium citrate salt crystalline coatings on treated surfaces to be protected against ignition by wildfire.

Another object of the present invention is to provide new and improved wildfire defense spraying system (WFDS) kits including chemical liquid storage tanks having a 50 or 100 gallon capacity and shipped preloaded with food-grade chemical constituents based on the weights and measures that support ASTM fire testing accreditations, EPA Safer Choice Labeling Certification, UL GreenGuard Gold Certification, and passes California Aquatic Testing and EPA and meets Prop 65—when the proper quantity of water is added and blended in the storage tank based on the manufacturer's instructions.

Another object of the present invention is to provide a new and improved system and method of mitigating the damaging effects of wild fires by spraying environmentally-clean fire inhibiting biochemical liquid on property prior to arrival of wildfire to form thin, optically-clear potassium salt crystalline coatings on combustible property, that inhibits fire ignition and flame spread without depending on water, so long as such potassium salt crystalline coatings remain present on the combustible property surfaces.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is schematic representation of the wireless system network of the present invention designed for managing the supply, delivery, and spray-application of the environmentally-clean anti-fire (AF) liquid composition of the present invention, on private and public property to reduce the risks of property damage and/or destruction and harm to life caused by wild fires;

FIG. 2 is a perspective view of an exemplary mobile computing device deployed on the system network of the present invention, supporting mobile fire inhibiting spray management applications of the present invention deployed as a component of the system network of the present invention as shown in FIG. 1;

FIG. 3 is a schematic representation showing the components in a wildfire defense spraying system installation kit for use in the quick and affordable assembly, installation and operation of a wildfire defense spraying system on a property parcel according to the method described in FIGS. 7A, 7B and 7C, which can be triggered to automatically spray and cover the property surfaces with an environmentally-clean liquid fire inhibitor, before the arrival of wildfire so as to reduce and mitigate the risk of loss of property and life due to wildfire.

FIG. 3A is a perspective view of the storage tank used for storing environmentally-clean liquid wildfire inhibitor chemicals in the sprinkler-based wildfire defense property spraying system of the present invention, when constructed from the kit of system components shown in FIG. 3;

FIG. 3B is a perspective view of the electric-motor driven fluid pump system that is used in the sprinkler-based wildfire defense property spraying system of the present invention, when constructed from the kit of system components shown in FIG. 3;

FIG. 3C1 is a perspective view of the 4G GSM remote power control switch module used, in conjunction with a smartphone and 4G GSM digital cellular communication network, to control 120V/30A electrical power supplied to the electric pump system in the sprinkler-based wildfire defense property spraying system of the present invention, when constructed from the kit of system components shown in FIG. 3;

FIG. 3C2 is a perspective view of the 4G GSM remote power control switch module of FIG. 3C1 shown with its weatherproof housing cover removed from the housing to reveal its internal circuit board, 4G GSM antenna, and electrical power relay bar to which wires are connected;

FIG. 3D1 is a perspective view of the 4G GSM GPS sensor that is permanently factory-mounted to the fire inhibitor storage tank that is used in the sprinkler-based wildfire defense property spraying system of the present invention, when constructed from the kit of system components shown in FIG. 3;

FIG. 3D2 is a perspective view of the 4G GSM GPS sensor of FIG. 3D1 shown with its battery power and SIM card module removed for access and activation;

FIG. 3E is a perspective view of one 360-degree (30′ range) sprinkler spray head device used in the sprinkler-based wildfire defense property spraying system of the present invention, when constructed from the kit of system components shown in FIG. 3;

FIG. 3F1 is a perspective view of a 4G GSM wireless remote wildfire ember and smoke detector module that can be optionally used in the sprinkler-based wildfire defense property spraying system of the present invention, when constructed from the kit of system components shown in FIG. 3, for the purpose of automatically activating and remotely triggering the spraying of specified property, with liquid fire inhibitor stored in the storage tank, prior to the actual arrival of the remotely-detected wildfire in the vicinity of the protected property region;

FIG. 3F2 is a perspective view of the 4G wireless remote automatic wildfire ember and smoke detector module for use in the sprinkler-based wildfire defense property spraying system of the present invention, when constructed from the kit of system components shown in FIG. 3;

FIG. 3G is a perspective view of the mixing nozzle for attachment to a garden house that can be used to add a quantity of water to the dry powder fire inhibitor chemicals that are preloaded into the storage tank at the factory, for making a liquid fire inhibitor in the storage tank at the system installation site, and used for spraying in the sprinkler-based wildfire defense property spraying system of the present invention when constructed from the kit of system components shown in FIG. 3;

FIG. 3H is a perspective view of the roll of PVC tubing for use in connecting the sprinkler heads, the electric pump system, the storage tank and 2-way valve assembly, and creating the fluid pumping circuit supporting the sprinkler-based wildfire defense property spraying system of the present invention, when constructed from the kit of system components shown in FIG. 3;

FIGS. 3I1 and 3I2 are perspective views of the lithium-battery electrical power storage system optionally used in providing an un-interrupted electrical power supply (UPS) from a 120/220V electrical power service to the electric pump system and other electrical power consuming components used in the sprinkler-based wildfire defense property spraying system of the present invention, when constructed from the kit of system components shown in FIG. 3;

FIG. 3J is a perspective view of a two-way flow valve assembly used to control (i) the flow of water from a water source into the electric pump when arranged in its first flow position during sprinkler sprayhead testing operations, and (ii) the flow of Citrotech® liquid fire inhibitor from the storage tank into the electric pump when arranged in its second flow position when the system is configured for fire inhibitor spraying operations;

FIG. 3K is a perspective view of the (optional) electrically-powered temperature-controlled immersible heating system for immersion in the chemical liquid stored in the storage tank of the wildfire defense spraying system of the present invention, when the system is constructed from the kit of system components shown in FIG. 3, to heat the liquid fire inhibitor in the storage tank as required to prevent freezing and malfunction of the system;

FIG. 3L1 is a perspective view of the (optional) electrically-powered temperature-controlled heating blanket adapted for wrapping about the storage tank used in the sprinkler-based wildfire defense property spraying system of the present invention, when constructed from the kit of system components shown in FIG. 3, to heat the liquid fire inhibitor in the storage tank as required to prevent freezing and malfunction of the system;

FIG. 3L2 is a perspective view of the electrically-powered temperature-controller designed for use with the heating blanket shown in FIG. 3L1, supplying electrical power to the heating elements within the blanket, and monitoring the temperature of the liquid fire inhibitor in the storage tank, as required to prevent freezing thereof and system malfunction;

FIG. 4A is a schematic representation illustrating the primary components of a first fire inhibiting biochemical composition kit of the present invention, consisting of major amounts of dry tripotassium citrate monohydrate (TPC) and minor amounts of triethyl citrate (TEC), as components in a package prepared and ready for mixing with a predetermined quantity of water functioning as a solvent, carrier and dispersant, to make up a predetermined quantity of environmentally-clean liquid fire inhibiting biochemical composition for proactively treating and protecting wood products;

FIG. 4B is a schematic representation illustrating the primary components of a first environmentally-clean aqueous-based fire inhibiting liquid biochemical composition of the present invention consisting of major amounts of tripotassium citrate (TPC) and minor amounts of triethyl citrate (TEC) formulated with water functioning as a solvent, carrier, and dispersant;

FIG. 5A is a schematic representation illustrating a process of forming a tripotassium citrate (TPC) crystalline structures on combustible surfaces, such as ground cover, native fuel, lumber, living plant tissue, tree bark, and other combustible tissue and like materials that are sprayed with atomized sprays, or otherwise coated, with the chemical material comprising the aqueous-based fire inhibiting solutions of the present invention;

FIG. 5B is a schematic representation illustrating the atoms and atom numbering in the crystal structure of the compound, tripotassium citrate (K3C6H5O7) formed on treated surfaces in accordance with the principles of the present invention;

FIG. 5C is a schematic representation of the atomic crystal structure of a small piece of the crystalline structure of tripotassium citrate (K3C6H5O7) salt structure formed on a substrate to be protected against fire by way of application of the fire inhibiting chemical solution of the present invention, graphically illustrated the stage C illustration of FIG. 5A when water molecules mixed therein have evaporated to the ambient environment during air-drying;

FIG. 6 is a block schematic representation of a generalized wireless remotely-activatable sprinkler-based wildfire defense fire inhibitor spraying system of the present invention, comprising: (i) a wildfire ember detection module for mounted on the top of a building to automatically detect the presence of a wildfire well before its arrival many miles away, and sensing a SMS-spray-triggering signal to the wireless remotely-activatable sprinkler-based wildfire defense fire inhibitor spraying system of the present invention, (ii) Storage Tank (50 or 100 Gallon) capacity for storage of dry powder fire inhibitor formulation loaded at the factory for mixing with an amount of water that is added to the storage tank at the time of installation and setup, (iii) 4G GSM GPS Sensor for mounting to the Storage Tank for monitoring the GPS location thereof, (iv) Electric Pump connected to the Storage Tank and a supply of pressurized water at installation location via a Valve assembly with first and second positions, (v) a Lithium-Battery Backup Power Supply System with photovoltaic (PV) recharging panel and 120 V line input from a local source of electrical power, for supplying electrical power to the electric pump, (vi) sprinkler spray heads, PVC piping for forming the necessary fluid pumping circuits from the electric pump to the sprinkler sprayheads during spraying operations, and (vii) a 4G GSMGPRS Transceiver and the Remote Power Control Switch for remotely controlling electrical power to the Electric Pump via the 4G GSM remote control power switch;

FIGS. 7A, 7B and 7C, taken together, shows a flow chart describing the steps to be undertaken when practicing the preferred method of assembling, installing, and operating the sprinkler-based wildfire defense fire inhibitor spraying system of the present invention, suitable for do-it-yourself (DYI) home-owner and contractor-assisted installations alike;

FIG. 8 is a schematic representation of an above-ground sprinkler-based firebreak spraying system installation of the present invention mounted on a building and property to spray the region with an environmentally-clear liquid fire inhibitor for defending against wildfire by inhibiting fire ignition and flame spread by hot flying wildfire embers created during a wildfire storm;

FIG. 9 is a block schematic representation of a wireless remotely-activatable sprinkler-based wildfire defense fire inhibitor spraying system of the present invention deployed in FIG. 8;

FIG. 10 is a schematic diagram showing the spray patterns generated by the sprinkler sprayheads mounted about the building, and driven by the wildfire defense fire inhibiting spraying system of this illustrative embodiment of the present invention;

FIG. 11 is a schematic representation of mobile smartphone being used to remotely activate the spraying of fire inhibitor before the arrival of a wildfire on the property of the system installation of FIGS. 9 and 10, using SMS supported by a 4G GSM digital cellular communication link between the smartphone and the 4G GSM remote power control switch employed at the spraying system installation;

FIG. 12 is a schematic representation of an above-ground sprinkler-based firebreak spraying system installation of the present invention configured before a property to be defended against wildfire by spraying a zone of fire inhibiting chemistry that inhibits fire ignition and flame spread by hot flying wildfire embers created during a wildfire storm;

FIG. 13 is a block schematic representation of a wireless remotely-activatable sprinkler-based wildfire defense fire inhibitor spraying system of the present invention deployed in FIG. 12;

FIG. 14 is a schematic diagram showing the resulting linear spray pattern generated by the sprinkler sprayheads mounted above the ground before the property to be protected and driven by the wildfire defense fire inhibiting spraying system of this illustrative embodiment of the present invention;

FIG. 15 is a schematic representation of mobile smartphone being used to remotely activate the spraying of fire inhibitor before the arrival of a wildfire on the property of the system installation of FIGS. 13 and 14, using SMS supported by a 4G GSM digital cellular communication link between the smartphone and the 4G GSM remote power control switch employed at the spraying system installation;

FIG. 16 is a schematic representation of an under-ground sprinkler-based firebreak spraying system installation of the present invention configured about a property to be defended against wildfire by spraying a zone of fire inhibiting chemistry that inhibits fire ignition and flame spread by hot flying wildfire embers created during a wildfire storm;

FIG. 17 is a cross-sectional block schematic representation of the wireless remotely-activatable sprinkler-based wildfire defense fire inhibitor spraying system of the present invention deployed in FIG. 16;

FIGS. 18A and 18B, taken together, set forth a schematic diagram showing the system of the present invention shown in FIGS. 16 and 17, providing an inground spraying solution around the property, wherein spreadheads, chemical storage tank and electric pump and components are mounted underground, and configured for automatically spraying preconfigured patterns of environmentally-clean fire inhibitor on ground surfaces requiring proactive protection against wildfires,

FIG. 19 is a schematic diagram showing the resulting linear spray pattern generated by the sprinkler sprayheads mounted underground before and/or about the property to be protected, and driven by the wildfire defense fire inhibiting spraying system of this illustrative embodiment of the present invention; and

FIG. 20 is a schematic representation of mobile smartphone being used to remotely activate the spraying of fire inhibitor before the arrival of a wildfire on the property of the system installation of FIGS. 18A, 18B and 19, using SMS supported by a 4G GSM digital cellular communication link between the smartphone and the 4G GSM remote power control switch employed at the spraying system installation.

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Wireless System Network for Managing the Supply, Delivery and Spray-Application of Environmentally-Clean Fire-Inhibiting Biochemical Liquid on Private and Public Property to Reduce the Risks of Damage and/or Destruction Caused by Wild Fires

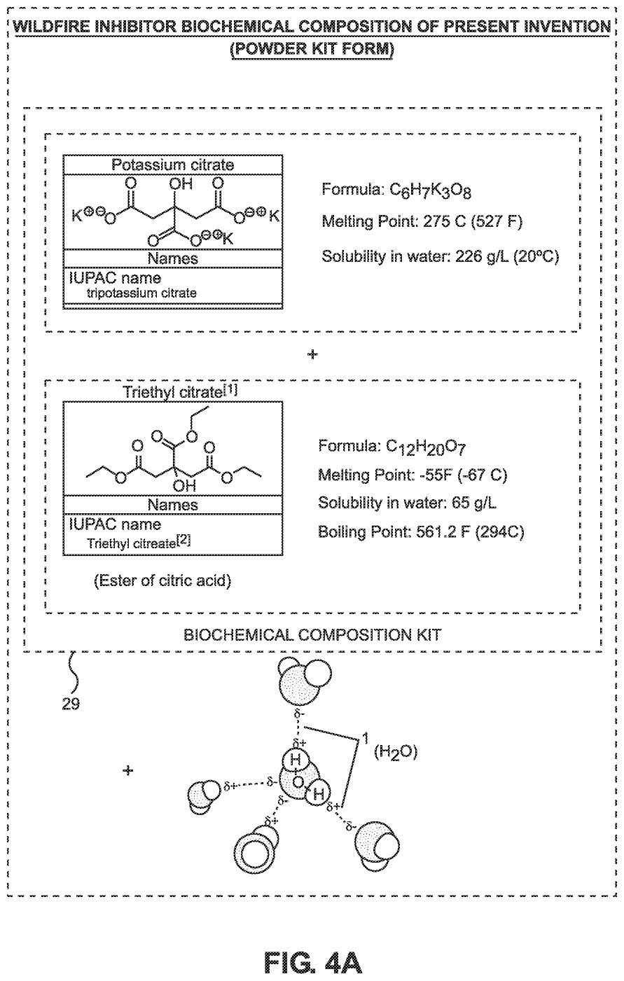

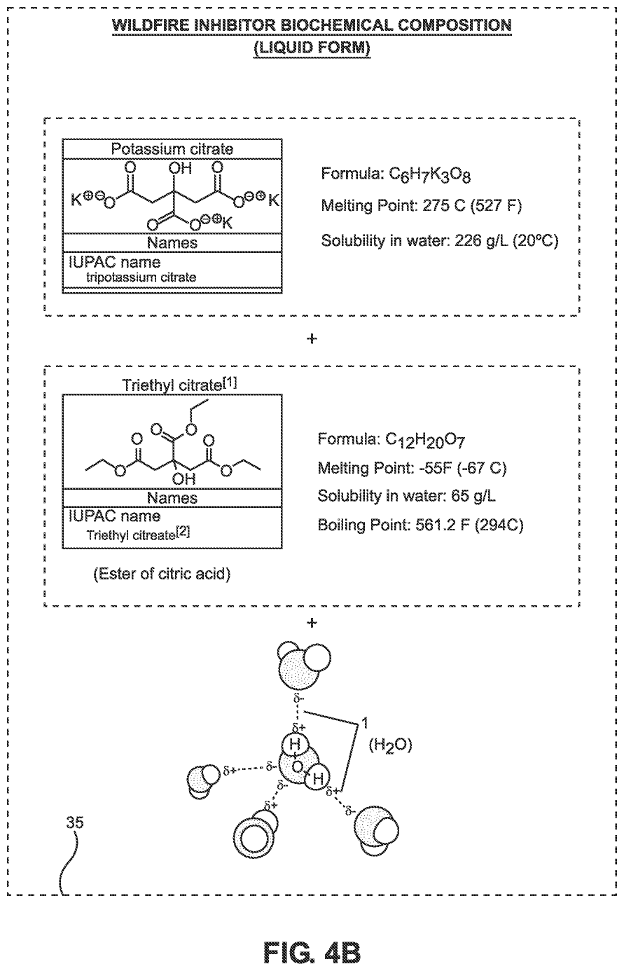

FIG. 4A shows the wireless system network of the present invention 1 designed for managing the supply, delivery, and spray-application of environmentally-clean anti-fire (AF) biochemical liquid composition of the present invention, on private and public property to reduce the risks of damage and/or destruction caused by wild fires. This system network is described in Applicant's U.S. Pat. No. 10,653,904B2, et al incorporated herein by reference. As disclosed therein, the system network comprises a distribution of system components, namely: GPS-tracked fire inhibiting (or anti-fire) liquid spray ground vehicles 2 (e.g. all-terrain vehicles or ATVs), for spray applying liquid chemical fire inhibitor, formulated according to the present invention, to ground surfaces, brush surfaces, and the surfaces of other forms of organic combustible material on property; GPS-tracked anti-fire liquid spray air-based vehicles 3, for applying fire inhibiting chemical liquid spray of the present invention (formulated as illustrated in FIGS. 4A and 4B and specified herein) from the air to ground surfaces, brush, bushes and other forms of organic material; GPS-tracked mobile anti-fire liquid back-pack spraying systems 4 (e.g. including wheel supported, and backpack-carried systems), for applying fire inhibiting chemical liquid spray to combustible ground surfaces, brush, bushes, decks, houses, buildings, and other forms of organic material and property surrounding houses; GPS-tracked/GSM-linked liquid spraying systems 5, for applying fire inhibiting chemical liquid spray to combustible surfaces on private real property, buildings and surrounding areas, and further specified in the present Patent Specification; GPS-tracked/GSM-linked liquid spraying systems 6, for applying fire inhibiting chemical liquid spray to combustible surfaces on public real property and buildings and surrounding properties; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked liquid supply and spray systems, including web servers 9A, application servers 9B and database servers 9C (e.g. RDBMS) operably connected to the TCP/IP infrastructure of the Internet 10, and including a network database 9C1, for monitoring and managing the system and network of GPS-tracking anti-fire liquid spraying systems and various functions supported by the command center 19, including the management of wild fire suppression and the GPS-guided application fire inhibiting chemical liquid over public and private property, as will be described in greater technical detail hereinafter. As shown, each data center 8 also includes an SMS server 9D and an email message server 9E for communicating with registered users on the system network 1 who use a mobile computing device (e.g. an Apple® iPhone or iPad tablet) 11 with the mobile application 12 installed thereon and configured for the purposes described herein. Such communication services will include SMS/text, email and push-notification services known in the mobile communications arts.

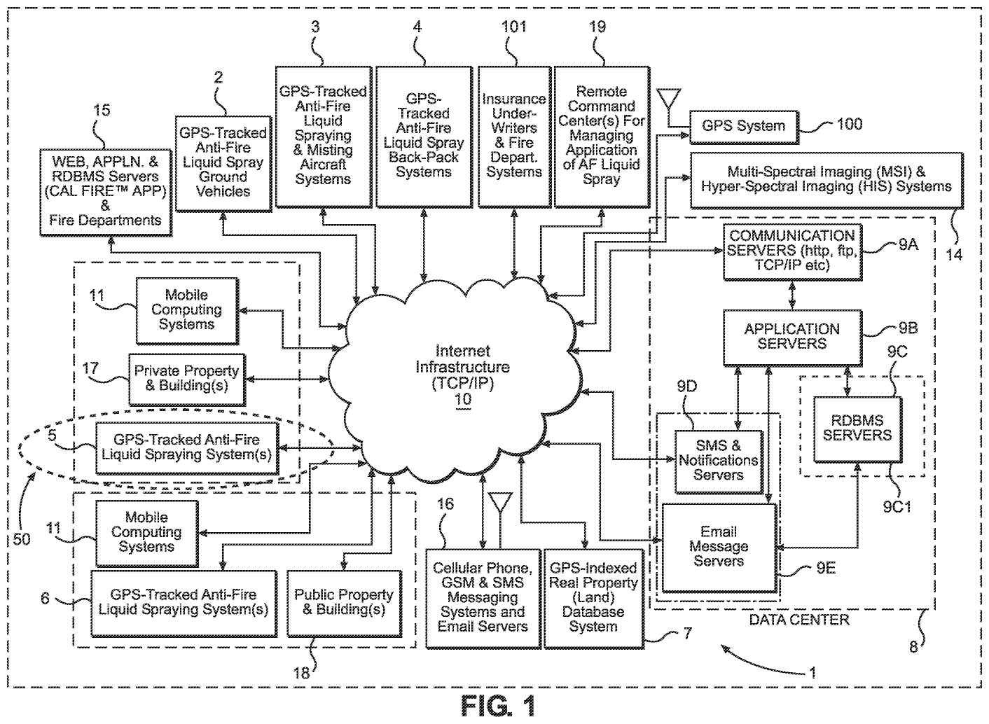

As shown in FIG. 1, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc.) used by spray-project technicians and administrators, and running a native mobile application 12 supported by server-side modules, supporting client-side and server-side processes on the system network of the present invention; and a GPS-tracked anti-fire liquid spraying systems for spraying buildings and ground cover to provide protection and defense against wild-fires. These subsystems are further specified in detail in U.S. Pat. No. 10,653,904B2.

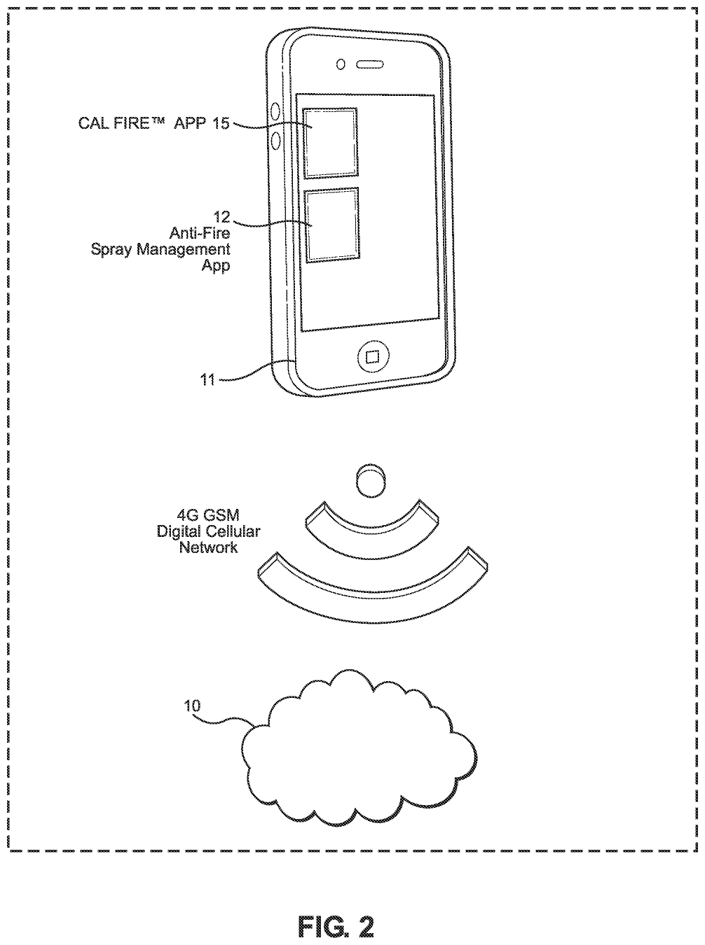

FIG. 2 shows an exemplary mobile computing device 11 deployed on the system network of the present invention. Such mobile computing systems support conventional wildfire alert and notification systems (e.g. CAL FIRE® wild fire notification system 14), as well as the mobile fire inhibitor spraying management application 12 of the present invention, that is deployed as a component of the system network 1. The features of mobile smartphone device 11 can be found in U.S. Pat. No. 8,631,358 incorporated herein by reference in its entirety.

Notably, new and improved the GPS-tracked/GSM-linked, sprinkler-based wildfire defense (fire inhibiting liquid) spraying systems 5 indicated in the system network of FIG. 1, and kits for constructing such systems, will be further specified in detail hereinafter in the present Patent Specification.

Specification of Environmentally-Clean Aqueous-Based Liquid Fire Inhibiting BioChemical Compositions and Formulations, and Methods of Making the Same at the Installation Site in Accordance with the Principles of the Present Invention

A primary object of the present invention is to provide new and improved environmentally-clean aqueous-based fire inhibiting biochemical solutions for use by homeowners around the world which demonstrate very good long-term fire inhibiting effects when being proactively applied to protect combustible surfaces against the threat of fire. In general, the novel fire inhibiting liquid biochemical compositions of the present invention comprise: (a) a dispersing agent in the form of a quantity of water, for dispersing metal ions dissolved in water; (b) a fire inhibiting agent in the form of at least one alkali metal salt of a nonpolymeric saturated carboxylic acid, for providing metal ions dispersed in the water when the at least one alkali metal salt is dissolved in the water; (c) a coalescing agent in the form of an organic compound containing three carboxylic acid groups (or salt/ester derivatives thereof), such as triethyl citrate, an ester of citric acid, for dispersing and coalescing the metal ions when the fire inhibiting liquid composition is applied to a surface to be protected against fire, while water molecules in the water evaporate during drying, and the metal ions cooperate to form potassium salt crystal structure on the surface; and (d) if appropriate, at least one colorant.

Useful alkali metal salts of nonpolymeric saturated carboxylic acids for inclusion in the compositions of the present invention preferably comprise: alkali metal salts of oxalic acid; alkali metal salts of gluconic acid; alkali metal salts of citric acid; and alkali metal salts of tartaric acid. Alkali metal salts of citric acid are particularly preferred, as will be further explained hereinafter.

Notably, while the efficacy of the alkali metal salts increases in the order of lithium, sodium, potassium, cesium and rubidium, the salts of sodium and salts of potassium are preferred for cost of manufacturing reasons. Potassium carboxylates are very particularly preferred, but tripotassium citrate monohydrate (TPC) is the preferred alkali metal salt for use in formulating the environmentally-clean fire inhibiting biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported the European Chemicals Agency (ECHA) handbook; and (iv) that tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the biochemical compositions of the present invention will be described in greater detail hereinafter.

Preferably, the water-soluble coalescing agent should have a melting point at least 32 F (0 C) or lower in temperature, and be soluble in water. Triethyl citrate (TEC) is a preferred coalescing agent when used in combination with tripotassium citrate (TPC) having excellent compatibility given that both chemical compounds are derived from citric acid.

In some applications, the use of colorants may be advantageous with or without opacifying assistants, to the fire inhibiting biochemical liquid compositions of the present invention. Opacifying assistants make the fire-retarding biochemical composition cloudy and prevent any interaction between the color of the added colorant used and the background color.

The concentration of the dye in the fire-retarding biochemical composition is preferably in the range from 0.005% to 10% by weight, more preferably in the range from 0.01% to 5% by weight and most preferably in the range from 0.015% to 2% by weight.

Of advantage are dyes, food dyes for example, which fade as the fire-retarding composition dries and gradually decompose or are otherwise easily removable, for example by flushing with water.

The fire inhibiting liquid biochemical compositions of the present invention are producible and prepared by mixing the components in specified amounts with water to produce the fire inhibiting composition. The order of mixing is discretionary. It is advantageous to produce aqueous preparations by mixing the components other than water, into water.

### Specification of Preferred Embodiments of the Dry Fire Inhibiting Biochemical Compositions of Matter Assembled as a Fire Inhibiting Biochemical Composition Kit

for Use with Specified Quantities of Water at System Installation Site In the preferred embodiment of the fire inhibiting liquid biochemical composition of the present invention, the components are realized as follows: (a) the fire inhibiting agent is realized in the form of an alkali metal salt of a nonpolymeric saturated carboxylic acid, specifically, tripotassium citrate, for providing metal potassium ions to be dissolved and dispersed in a quantity of water (supplied at the time and site of system installation at the homeowner's property); (b) a coalescing agent realized the form of an organic compound containing three carboxylic acid groups (or salt/ester derivatives thereof), specifically triethyl citrate, an ester of citric acid, for dispersing and coalescing the metal potassium ions when the fire inhibiting liquid composition is applied to a surface to be protected against fire, and while water molecules in the water evaporate during drying, the metal potassium ions cooperate to form potassium citrate salt crystal structure on the treated surface.

### Selecting Tripotassium Citrate (TCP) as a Preferred Fire Inhibiting Agent for Use in the Fire Inhibiting Biochemical Compositions of the Present Invention

In the preferred embodiments of the present invention, tripotassium citrate (TPC) is selected as active fire inhibiting chemical component in fire inhibiting biochemical composition. In dry form, TPC is known as tripotassium citrate monohydrate (C₆H₅K₃O₇·H₂O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Care should be taken not to expose tripotassium citrate monohydrate to high pressure during transport and storage as this may result in caking. Tripotassium citrate monohydrate is considered “GRAS” (Generally Recognized As Safe) by the United States Food and Drug Administration without restriction as to the quantity of use within good manufacturing practice. CAS Registry Number:[6100-05-6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

Selecting Triethyl Citrate (TEC) as a Preferred Coalescing Agent with Surface Tension Reducing and Surfactant Properties for Use in the Fire Inhibiting Biochemical Compositions of the Present Invention

In the preferred illustrative embodiments of the present invention, the coalescing agent used in the fire inhibitor biochemical compositions of the present invention is realized as a food-grade additive component, namely, triethyl citrate (TEC) which functions as a coalescing agent with surface tension reducing properties and surfactant properties as well. Triethyl citrate belongs to the family of tricarboxylic acids (TCAs) and derivatives, organic compounds containing three carboxylic acid groups (or salt/ester derivatives thereof).

In the aqueous-based fire inhibiting liquid composition, the coalescing agent functions as temporary dispersing agent for dispersing the metal ions dissolved and disassociated in aqueous solution. As water molecules evaporate from a coating of the biochemical composition, typically spray/atomized applied to a surface to be protected from fire, the coalescing agent allows the formation of thin metal (e.g. potassium citrate) salt crystal structure/films at ambient response temperature conditions of coating application. The coalescent agent promotes rapid potassium salt crystalline structure/coating formation on combustible surfaces to be protected against wildfire, and have a hardness evolution that promotes durability against rain and ambient moisture, while apparently allowing vital oxygen and CO2 gas transport to occur, without causing detrimental effects to the vitality of living plant tissue surfaces sought to be protected against wildfire.

A relatively minor quantity of triethyl citrate (TEC) liquid is blended with a major quantity of TCP powder in specific quantities by weight and dissolved in a major quantity of water to produce a clear, completely-dissolved liquid biochemical formulation consisting of food-grade biochemicals mixed with water and having highly effective fire inhibiting properties, as proven by testing. The resulting aqueous biochemical solution remains stable without the formation of solids at expected operating temperatures (e.g. 34 F to 120 F).

Jungbunzlauer (JBL) also manufactures and distributes its CITROFOL® A1 branded bio-based citrate esters for food-grade, healthcare, pharmaceutical and over the counter (OTC) applications around the world. CITROFOL® A1 triethyl citrate (TEC) esters have an excellent toxicological and eco-toxicological profile, and provide good versatility and compatibility with the tripotassium citrate (TPC) component of the biochemical compositions of the present invention. CITROFOL® A1 branded citrate esters are particularly characterized by highly efficient solvation, low migration, and non-VOC (volatile organic compound) attributes. As an ester of citric acid, triethyl citrate is a colorless, odorless liquid which historically has found use as a food additive (E number E1505) to stabilize foams, especially as a whipping aid for egg whites.

Broadly described, the fire inhibiting biochemical liquid coatings of the present invention consist of an aqueous dispersion medium such as water which carries dissolved metal salt cations that eventually form a thin metal salt crystalline structure layer on the surface substrate to be protected from ignition of fire. The aqueous dispersion medium may be an organic solvent, although the preferred option is water when practicing the present invention. After the application of a coating onto the combustible surface to be protected against fire ignition and flame spread and smoke development, the aqueous dispersion medium evaporates, causing the metal salt (i.e. potassium salt) cations to draw together. When these metal salt particles come into contact, the coalescing agent, triethyl citrate, takes effect, uniformly dispersing the same while reducing liquid surface tension, and giving rise to the formation of a relatively homogeneous metal salt crystalline structure layer over the surface. In practice, this interaction is more complex and is influenced by various factors, in particular, the molecular interaction of the potassium salt cations and the coalescing agent, triethyl citrate, as the water molecules are evaporating during the drying process.

While offering some surface tension reducing effects, the main function of the coalescing agent in the biochemical composition of the present invention is to ensure a relatively uniform and optimal formation of the salt crystalline structure layers on the combustible surfaces to be protected, as well as desired mechanical performance (e.g. offering scrub resistance and crystal coating hardness) and aesthetic values (e.g. gloss and haze effects).

The fact that CITROFOL® A1 triethyl citrate (TEC) esters are bio-based, odorless, biodegradable, and label-free, represents a great advantage over most other coalescing agents, and fully satisfies the toxicological and environmental safety requirements desired when practicing the biochemical compositions of the present invention.

In the preferred embodiments of the present invention, the use of CITROFOL® A1 triethyl citrate (TEC) esters with tripotassium citrate monohydrate (TPC) dissolved in water as a dispersion solvent, produce fire inhibiting biochemical formulations that demonstrate excellent adhesion, gloss, and hardness properties. The chemical and colloidal nature of potassium salt ions (which are mineral salt dispersions) present in TPC dissolved in water, is highly compatible with the CITROFOL® A1 triethyl citrate (TEC) ester used as the coalescing agent in the preferred embodiments of the present invention. Also, CITROFOL® A1 triethyl citrate esters are REACH registered and are safe, if not ideal, for use in environmentally sensitive products such as fire and wildfire inhibitors which must not adversely impact human, animal and plant life, ecological systems, or the natural environment.

### Specification of Preferred Formulations for the Fire Inhibiting Biochemical Compositions of Matter According to the Present Invention

### Example #1: Dry-Powder Fire Inhibiting Biochemical Composition (Made on Site)

FIG. 4A illustrates the primary components of a first fire inhibiting biochemical composition kit of the present invention, consisting of dry tripotassium citrate (TPC) and triethyl citrate (TEC) components for mixing with a predetermined quantity of water functioning as a solvent, carrier, and dispersant, to make up a predetermined quantity of environmentally-clean liquid fire inhibiting biochemical composition for proactively protecting wood products.

Example 1: Schematically Illustrated in FIG. 4A: A fire-extinguishing and/or fire-retarding biochemical composition was produced by blending the following components, in amounts proportional to the formulation comprising: 0.05 pounds by weight of triethyl citrate as coalescing agent, (20.3 milliliters by volume); 5.2 pounds by weight of tripotassium citrate (64 fluid ounces by volume); packaging the blended components together in a container or package for mixing with 4.4 pounds by weight of water (64 fluid ounces by volume), to produce a resultant solution of total weight of 9.61 pounds having 128 ounces or 1 gallon of volume. A primary advantage of this dry powder embodiment of the present invention is achieving significantly reduced shipping costs for the finished goods, because of the significant reduction in weight of finished goods achieved by eliminating the weight of water from the formulation prior to shipping. Specifically, a reduction in weight of 416 lbs. is for the 50-gallon storage tank, and a reduction in weight of 833 lbs. is achieved for a 100-gallon storage tank, because each US gallon of water weighs approximately 8.33 lbs.

In the preferred embodiment, the WFDS kit of the present invention is equipped with fire inhibitor storage tanks having either a 50 or 100 gallon capacity, to support different size property sizes, and will be shipped from the factory containing all Citrotech® fire inhibitor constituents based on weights and measures required to support ASTM fire testing accreditations along with UL GreenGuard Gold, LENS, California Aquatic Testing, EPA Safer Choice Labeling, and meeting Prop 65, but only when the proper quantity of water has been added (indicated by the water fill line) and blended properly based on manufacturer's instructions for filling the storage tank.

### Example #2: Liquid-Based Fire Inhibiting Biochemical Composition (Made at Factory)

In this alternative embodiment shown in FIG. 4B, illustrates the primary components of a first environmentally-clean aqueous-based fire inhibiting liquid biochemical composition of the present invention are mixed at the factory under strict quality control, and consist of tripotassium citrate (TPC) and triethyl citrate (TEC) formulated with water functioning as a solvent, carrier, and dispersant in the biochemical composition.

Example 2: A fire-extinguishing and/or fire-retarding biochemical composition was produced by stirring the components into water. The composition comprising: 0.05 pounds by weight of triethyl citrate as coalescing agent, (20.3 milliliters by volume); 5.2 pounds by weight of tripotassium citrate (64 fluid ounces by volume); and 4.4 pounds by weight of water (64 fluid ounces by volume), to produce a resultant solution of total weight of 9.61 pounds having 128 ounces or 1 gallon of volume. A primary disadvantage of this embodiment of the invention is the cost of the finished goods, weighing in at least 8.4 lbs. per gallon of water used, which contributes significantly to the cost of shipping.

### Preferred Weights Percentages of the Components of the Fire Inhibiting Biochemical Formulation of the Present Invention

In the biochemical compositions of the present invention The ratio of the ester of citrate (e.g. triethyl citrate) to the alkali metal salt of a nonpolymeric carboxylic acid (e.g. tripotassium citrate) may be major amount between 1:100: to 1:1000 and is typically in the range from 1:1 to 1:100, preferably in the range from 1:2 to 1:50, more preferably in the range from 1:4 to 1:25 and most preferably in the range from 1:8 to 1:15.

A preferred biochemical composition according to the present invention comprises: a major amount from 1% to 65% by weight, preferably from 20% to 50% by weight and more preferably from 30% to 55% by weight, of at least one alkali metal salt of a nonpolymeric saturated carboxylic acid (e.g. tripotassium citrate monohydrate or TPC); and minor amount from 0.08% to 5% by weight, preferably from 0.5% to 2% by weight and more preferably from 0.1% to 1.0% by weight, of triethyl citrate (an ester of citrate acid); wherein the sum by % weight of the components (a) and (b) should not exceed 100% by weight.

In a preferred embodiment, the fire inhibiting composition further comprises water. The water content is present in a major amount and is typically not less than 30% by weight, preferably not less than 40% by weight, more preferably not less than 50% by weight and most preferably not less than 60% by weight and preferably not more than 60% by weight and more preferably not more than 70% by weight, all based on the fire inhibiting biochemical composition.

The viscosity of the aqueous preparation is preferably at least 5 [mPas](millipascal-seconds, in SI units, defined as the internal friction of a liquid to the application of pressure or shearing stress determined using a rotary viscometer), and preferably not more than 50 [mPas], or 50 centipois) [cps], for most applications.

### Physical Examination and Fire-Performance Testing of Thin Potassium Salt Crystalline Coatings Formed Using the Biochemical Compositions and Methods and Apparatus of the Present Invention

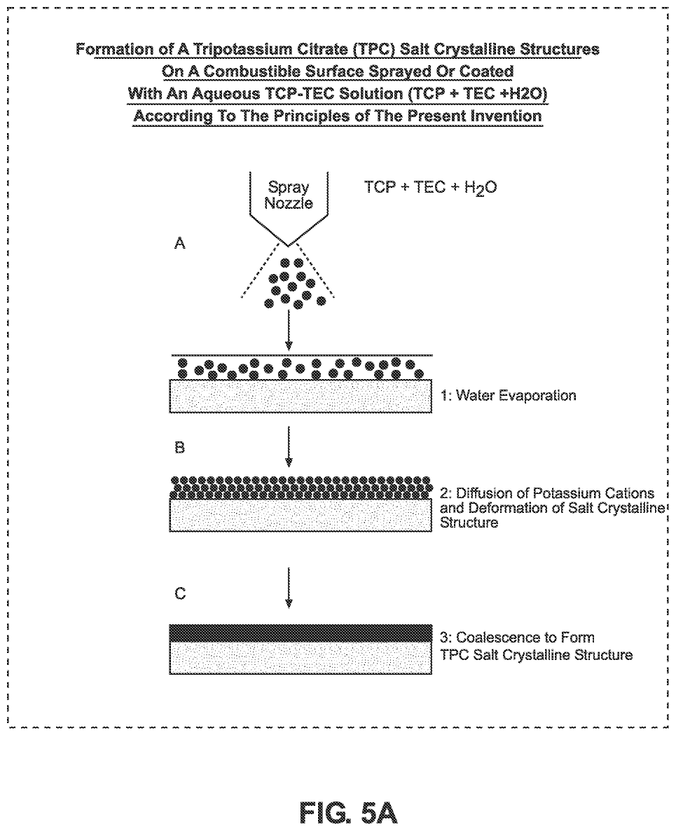

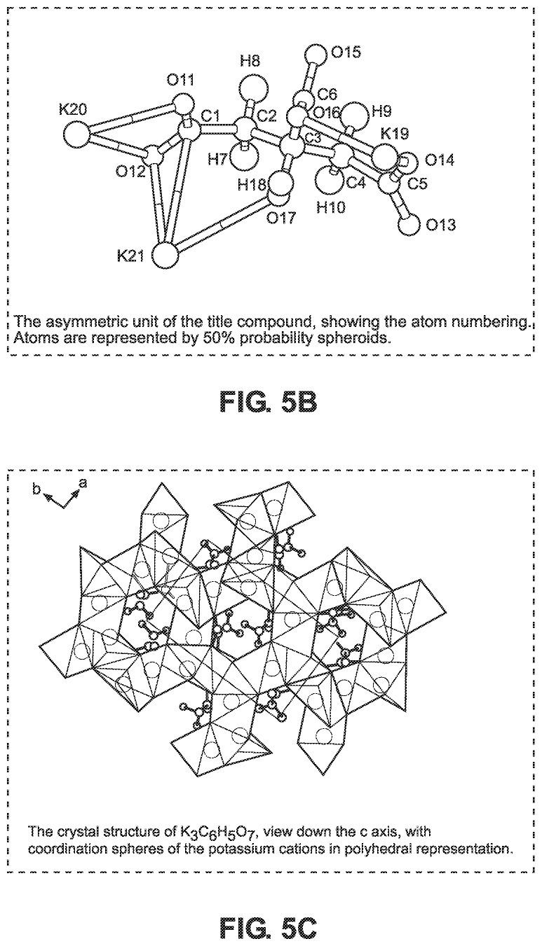

One method of viewing the resulting potassium salt crystal structures formed upon a surface substrate to be protected against fire, as illustrated in FIG. 5A, would be by using atomic force microscope to form atomic force microscopy (AFM) images of the biochemical coatings applied in accordance with the principles of the present invention. Another method of viewing the resulting potassium salt crystal structures would be to use a scanning electron microscope to form scanning electron microscopy (SEM) images. Expectedly, using either instrument, such images of potassium salt crystal structures formed using a greater wt. % of coalescent agent (e.g. triethyl citrate dissolved in water with tripotassium citrate) will show that the coalescent agent resulted in metal salt crystal structures that are more coalesced and smoother, and demonstrating higher hardness evolution and better water repulsion, than when the potassium salt crystal structures are formed using a lower wt. % coalescent agent in the aqueous-based fire inhibiting liquid composition.

FIG. 5A illustrates the primary steps involved during the formation of tripotassium citrate (potassium) salt crystalline structure coatings on spray treated surfaces to be proactively protected against ignition and flame spread of incident fire.

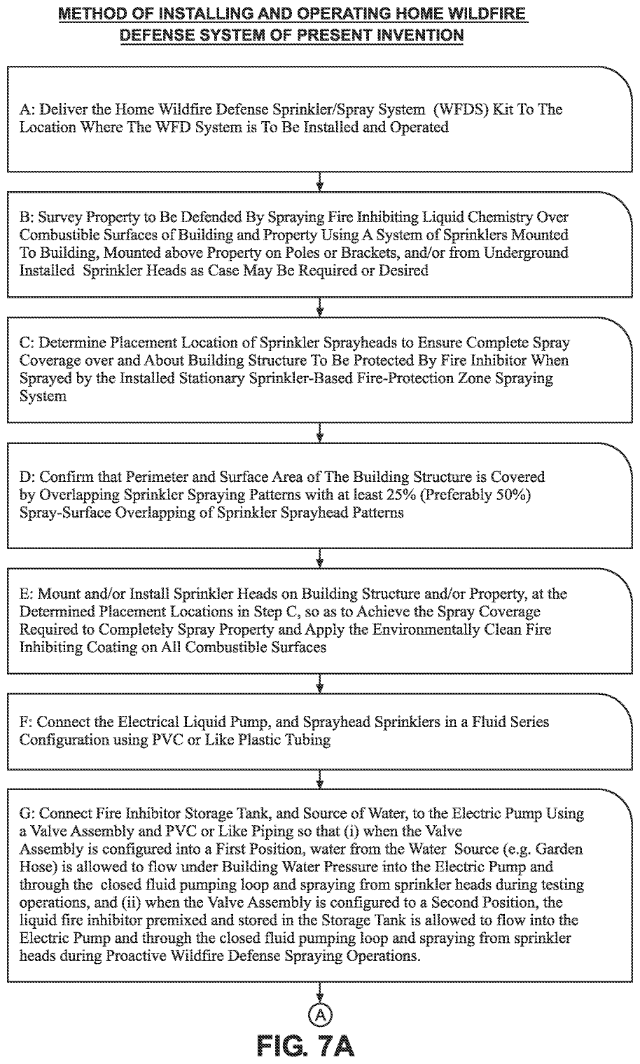

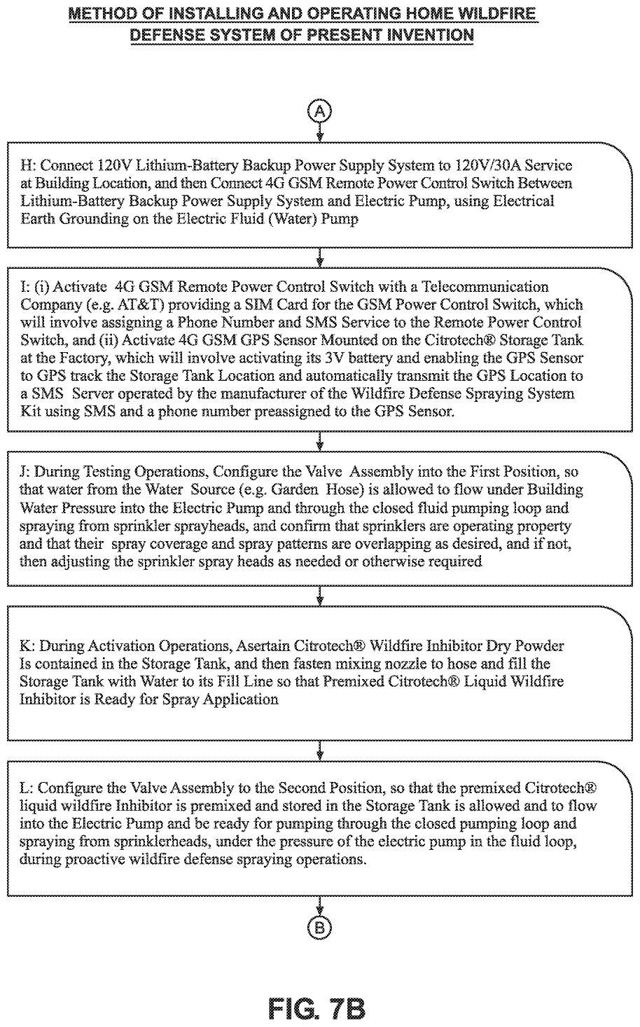

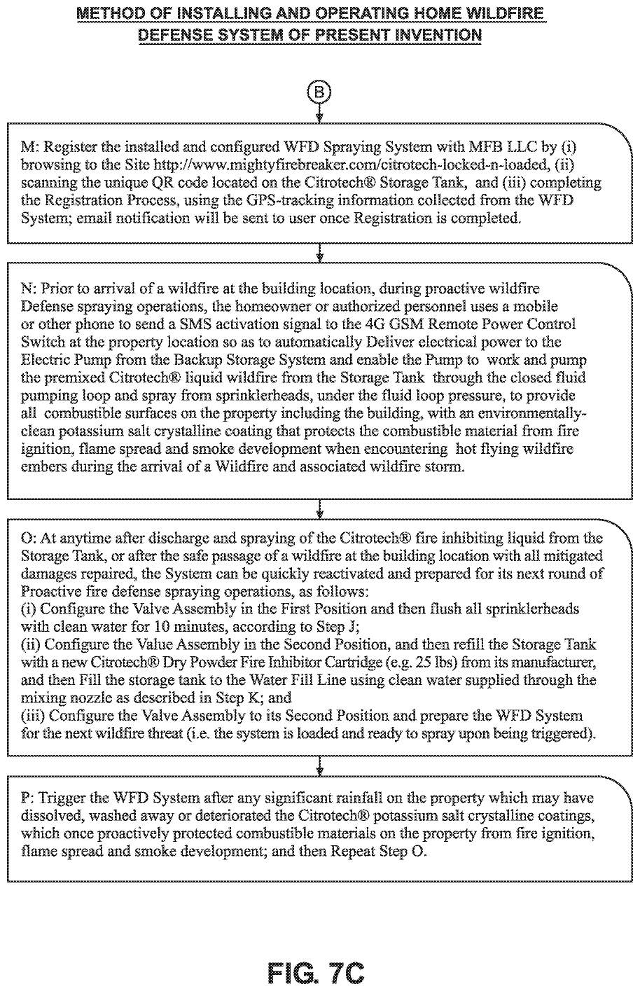

At Step A, a spray nozzle is used to spray a liquid coating of a biochemical composition of the present invention, and once applied, the water molecules being to evaporate at a rate determined by ambient temperature and wind currents, if any. When the minimum film formation temperature (MFT) is reached for the biochemical composition, the potassium cations can inter diffuse within the triethyl citrate (TEC) coalescent agent and water molecule matrix that is supported on the surface that has been sprayed and to be proactively treated with fire inhibiting properties by virtue of a thin film deposition of tripotassium salt crystalline structure, modeled and illustrated in FIGS. 7B and 7C.

At Step B, potassium cations diffuse and the TPC crystalline structure deforms. During the coalescence of potassium cations, interparticle potassium cation diffusion (PCD) occurs within the TEC coalescing agent to produce a semi-homogenous tripotassium citrate salt crystalline structure.

At Step C, coalescence occurs to form the TPC salt crystalline structure. The mechanical properties of tripotassium citrate crystalline structures are highly dependent on the extent of PCD within the TEC coalescent agent.

Upon complete evaporation of water molecules from the biochemical liquid coating, the resulting fire inhibiting coating that is believed to be formed on the sprayed and dried surface comprises a thin film of tripotassium citrate salt crystalline structures formed on the structure, with substantially no water molecules present. The nature and character of such tripotassium citrate salt crystalline structures are believed to be reflected in models provided in FIGS. 5 and 5C, which were first reported in 2016 in a published research paper by Alagappa Rammahon and James A. Kaduk, titled “Crystal Structure of Anhydrous Tripotassium Citrate From Laboratory X-Ray Diffraction Data and DFT Comparison” cited in ACTA CRYSTL (2016) Vol. E72, Pages 1159-1162, and published by Crystallographic Communications.

To determine and confirm that the fire inhibiting liquid compositions of the present invention produce potassium citrate salt crystalline structures on treated surfaces that have attained certain standards of fire inhibiting protection, it is necessary to test such treated surface specimens according to specific fire protection standards. In the USA, ASTM E84 Flame Spread and Smoke Development Testing can be used to test how well surfaces made of wood, cellulose and other combustible materials perform during E84 testing, and then compared against industry benchmarks. The environmentally-clean fire inhibiting chemical liquid composition disclosed herein is currently being tested according to ASTM E84 testing standards and procedures, and these ASTM tests have shown that fire-protected surfaces made of Douglas Fir (DF) demonstrate Flame Spread Indices and Smoke Development Index to qualify for Class-A fire protected certification, when treated by the fire inhibiting biochemical composition of the present invention disclosed and taught herein.

### Specification of Wireless Remotely-Activatable Sprinkler-Based Wildfire Defense Fire Inhibitor Spraying System of the Present Invention

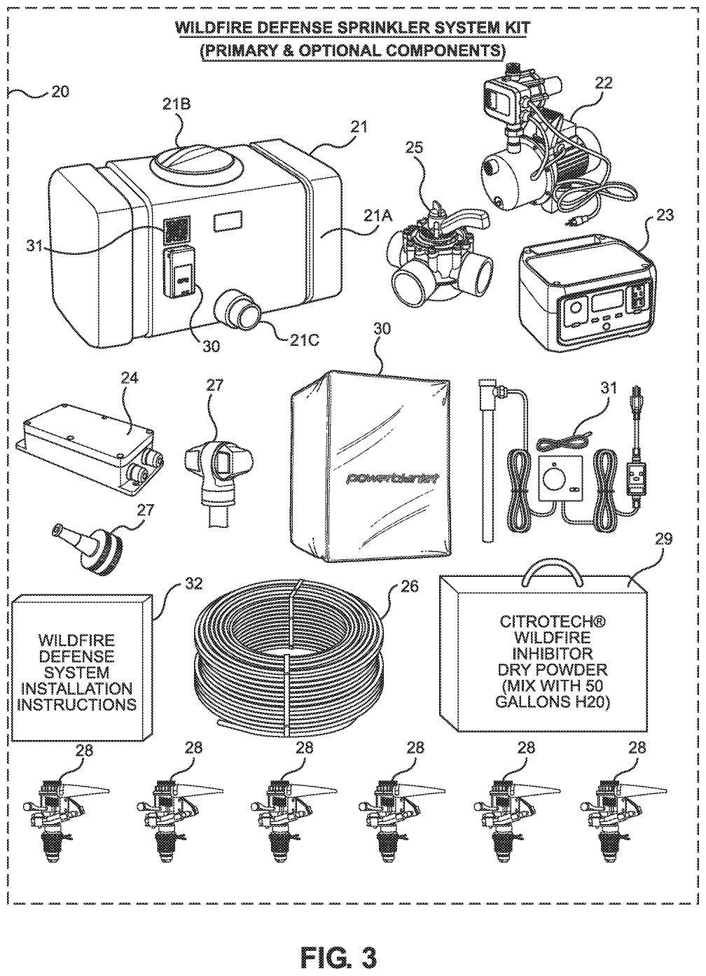

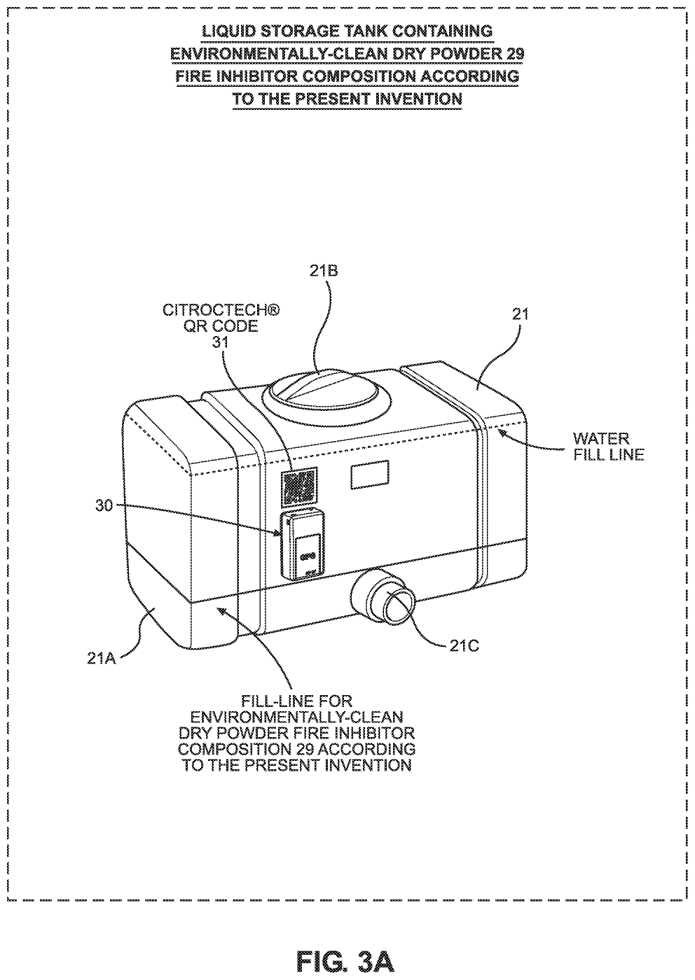

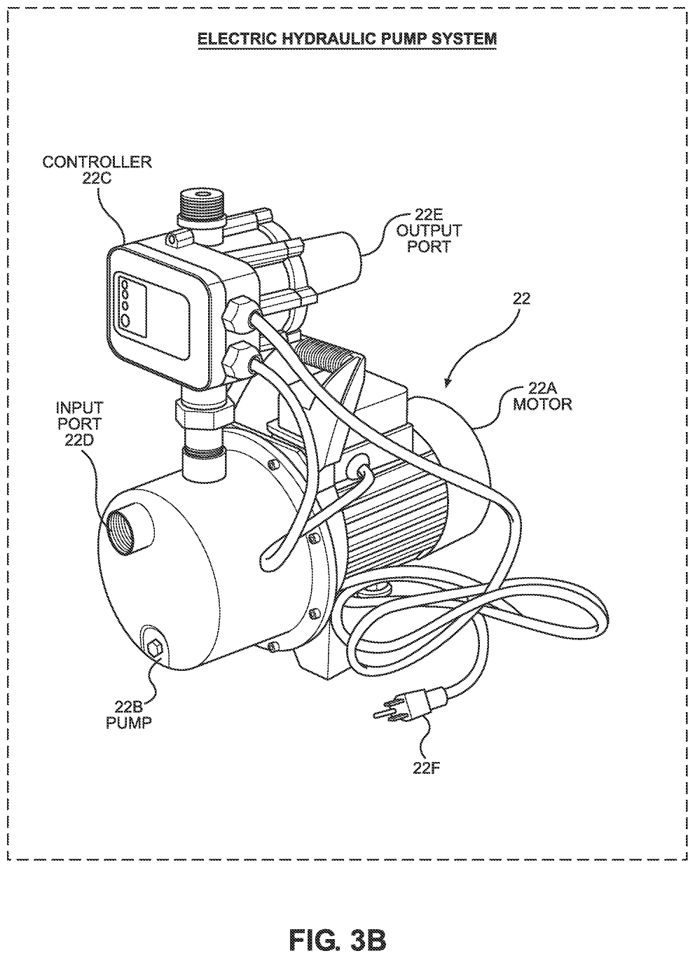

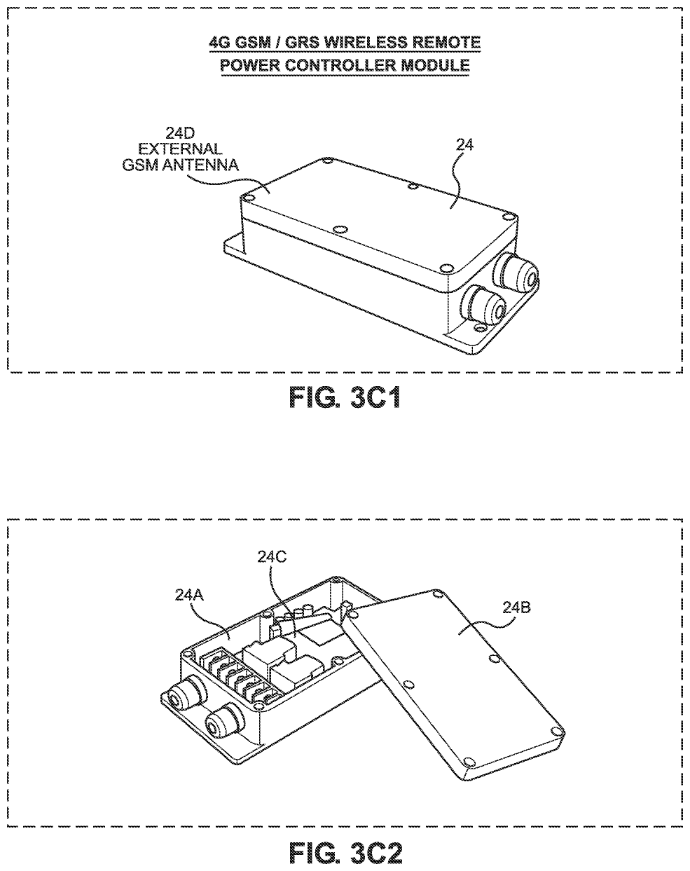

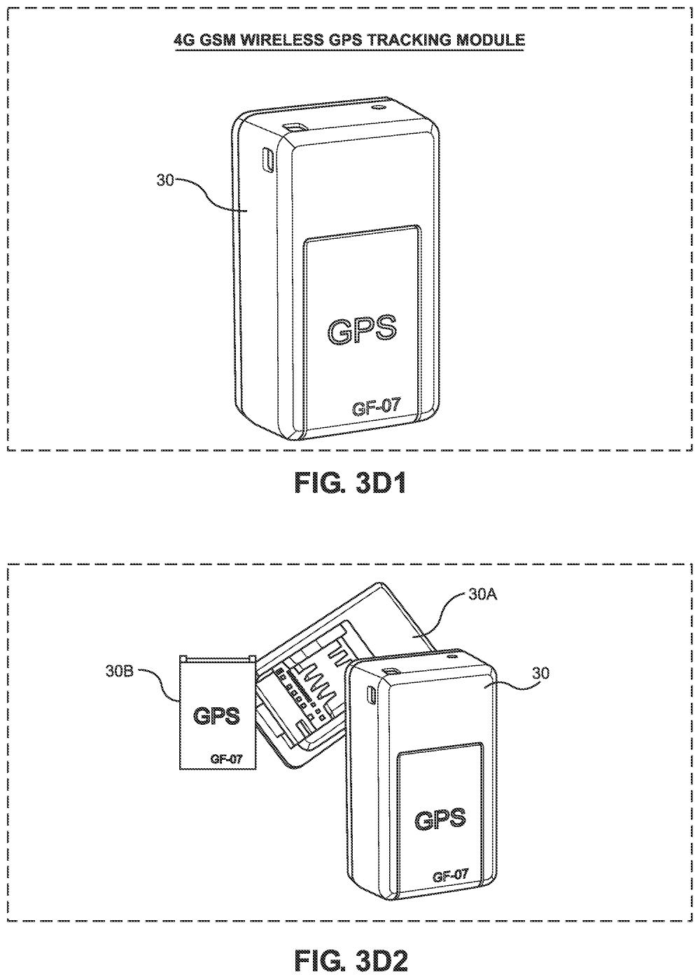

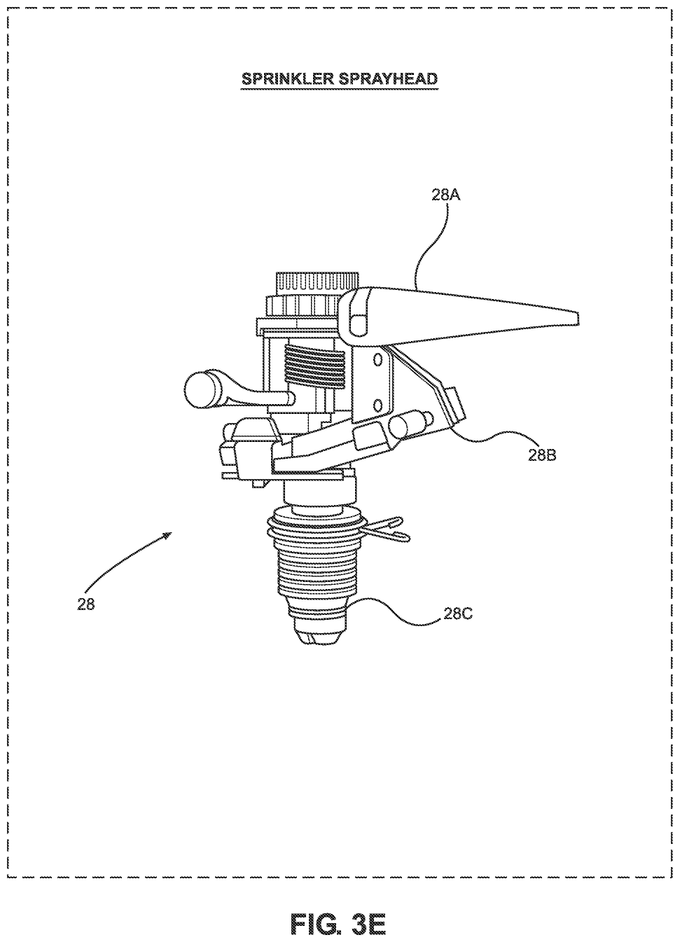

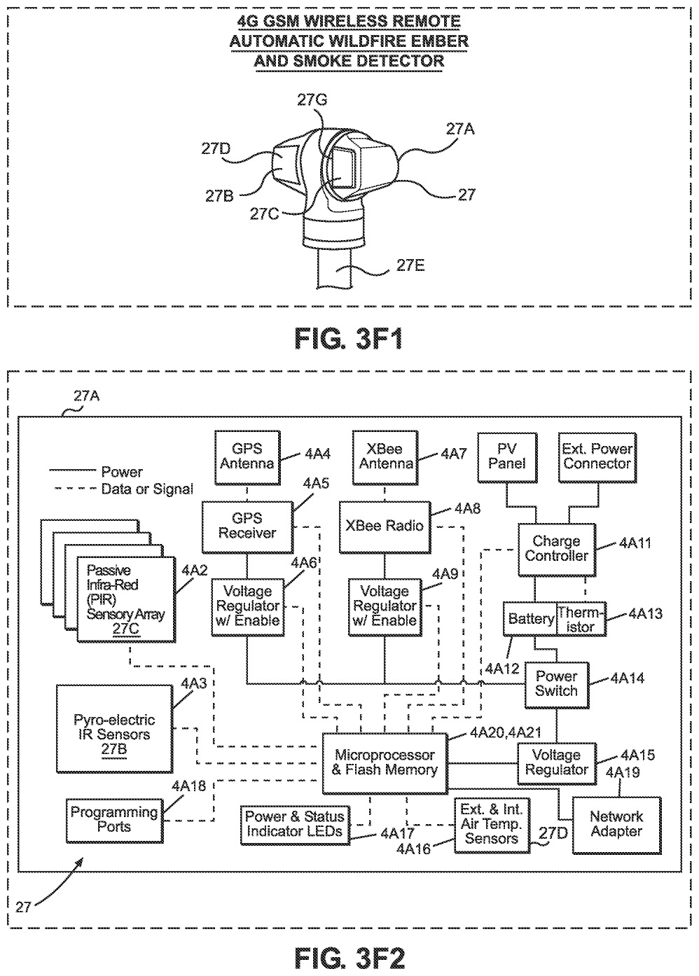

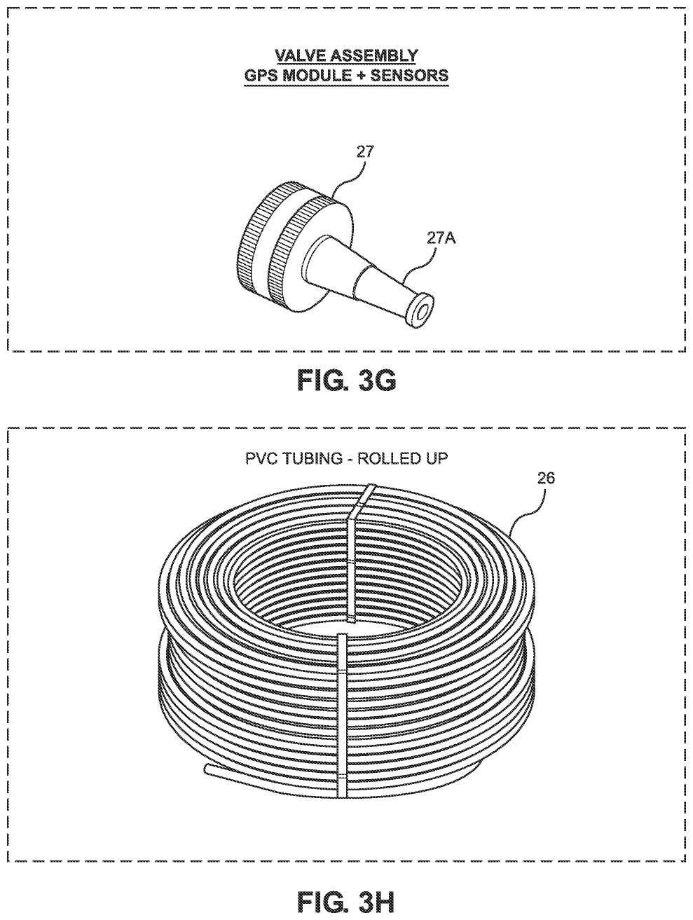

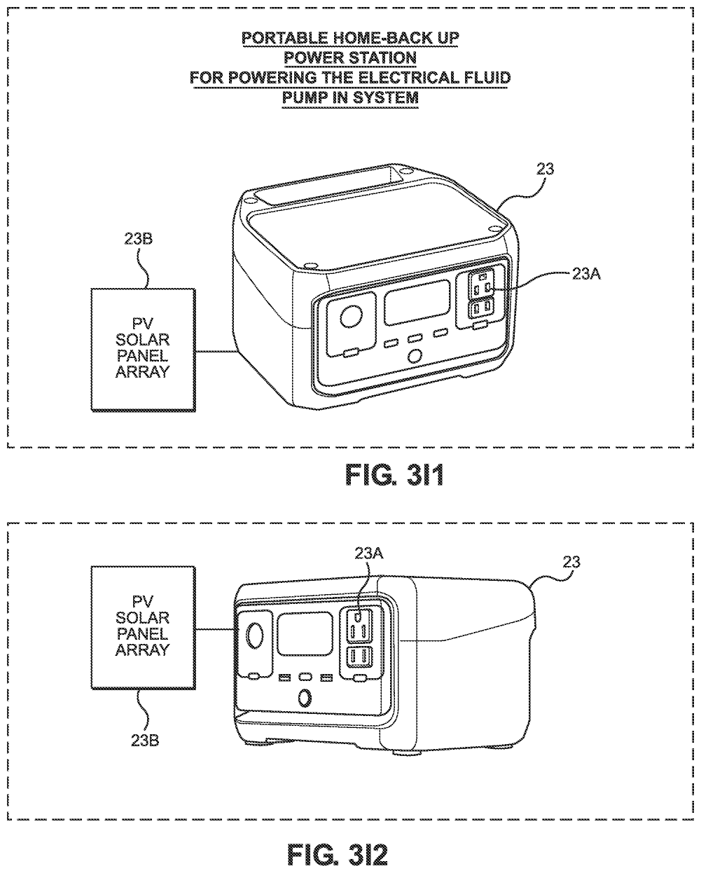

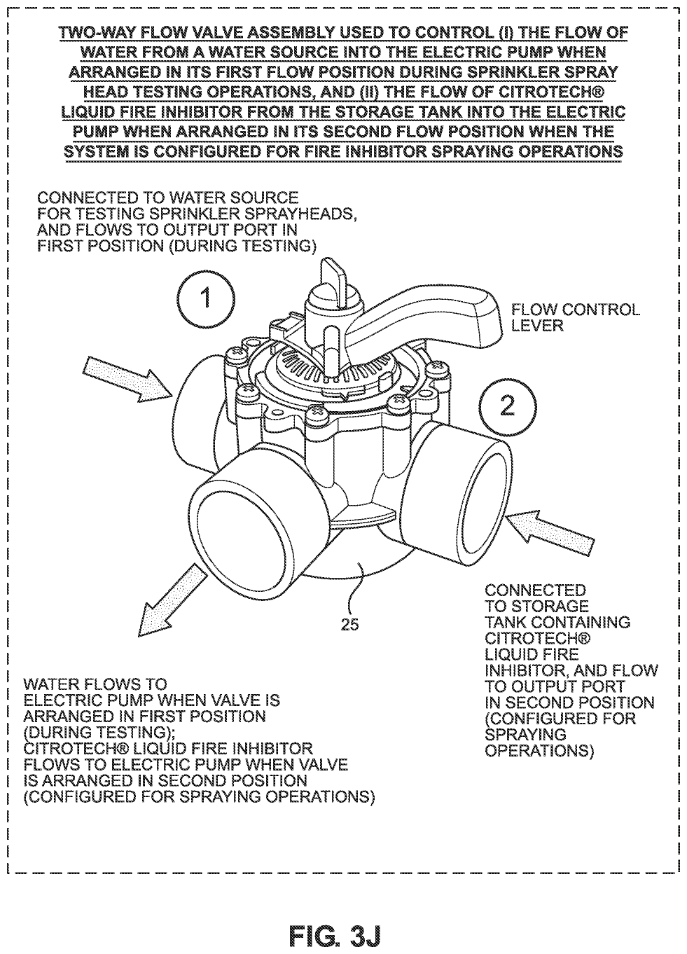

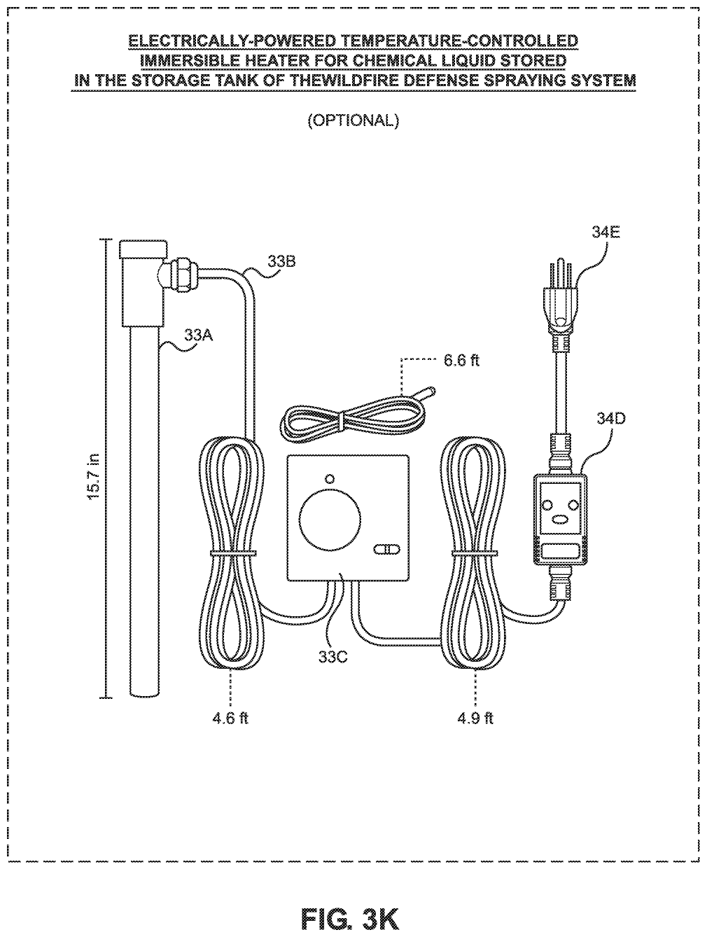

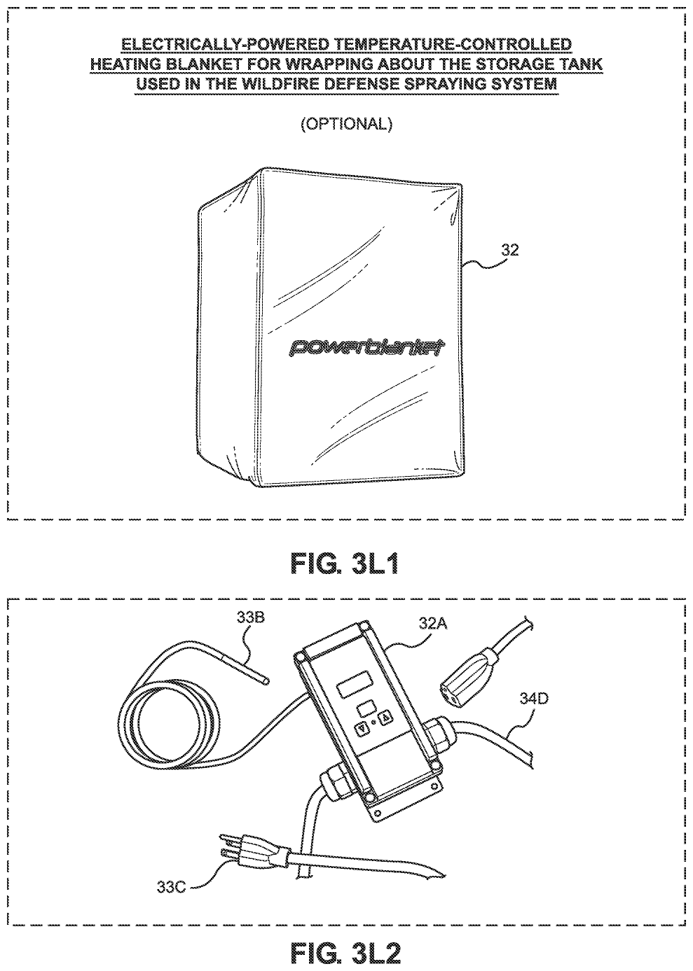

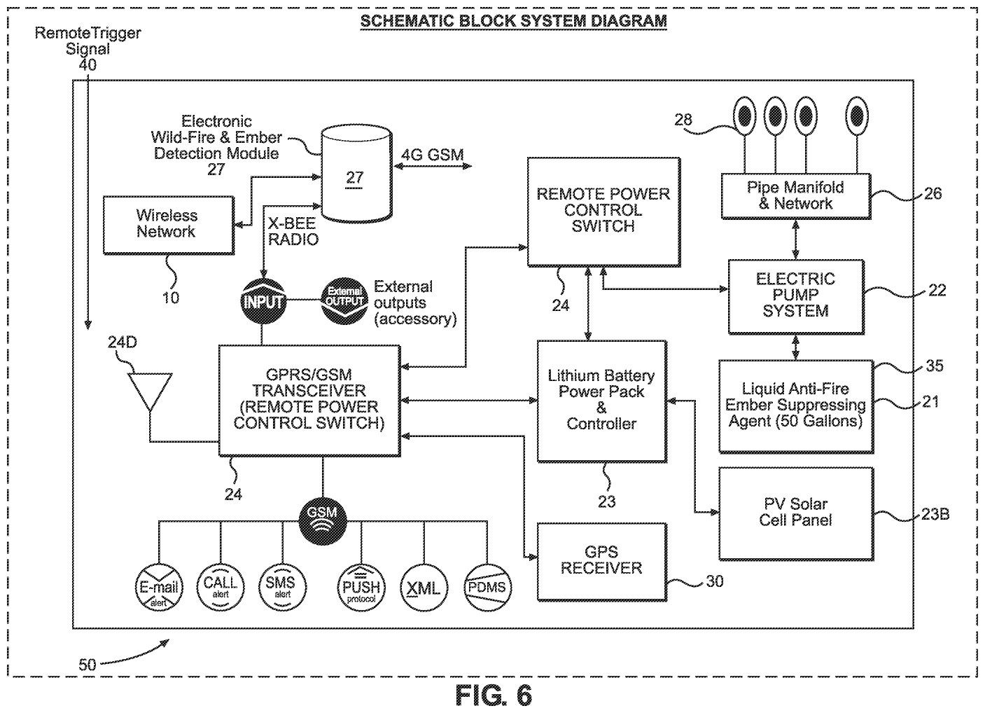

FIG. 6 shows a generalized wireless remotely-activatable sprinkler-based wildfire defense fire inhibitor spraying system (WFDS) of the present invention 50, comprising the following components contained in WFDS kit 20, namely: (i) a wildfire ember detection module 2 shown in FIGS. 3E1 and 3E2 for mounting on the top of a building, pole or tree to automatically detect the presence of a wildfire (i.e. via automated wildfire ember and/or smoke detection) well before its arrival many miles away, and sensing a SMS-spray-triggering signal 40 to the wireless remotely-activatable sprinkler-based wildfire defense fire inhibitor spraying system of the present invention 20 operate the automated spraying of Citrotech® liquid fire inhibitor 35 all over the property to be protected from fire ignition and/or flame spread by an incident wildfire; (ii) a plastic, fiberglass or metallic storage tank 21 shown in FIG. 3A having a 50 or 100 US gallon liquid storage capacity, for storage of dry powder fire inhibitor formulation 29 loaded at the factory for mixing and blending with a specified amount of water that is added to the storage tank 21 at the time of installation and setup according to the chemical formulation of the present invention; (iii) a 4G GSM GPS sensor 30 shown in FIGS. 3D1 and 3D2 for mounting to the storage tank 21 for monitoring the GPS location thereof using 4G GSM digital cellular communications (e.g. AT&T); (iv) an electric-motor (120V/20-30A) fluid hydraulic pump 22 shown in FIG. 3A, operably connected to the storage tank 21 and a supply of pressurized water at installation location via a valve assembly 25 having first and second (flow directing) positions; (v) a Lithium-battery backup power supply system (e.g. EcoFlow® River 2 Pro Portable Power Station—768 Wh capacity and 800 W output) 23 shown in FIGS. 311 and 312, provided with photovoltaic (PV) recharging panel for recharging the lithium-ion battery 23 while collecting sunlight with the PV solar panel as solar conditions allow, and 120 V line input plug for connection to a local source of electrical power, for supplying electrical power to the electric pump 22; (vi) at least 4 to 6 sprinkler spray heads 28 shown in FIG. 3E provided with conventional roof/pole mounting brackets, for spraying the Citrotech® liquid fire inhibitor 35 in the storage tank, all over the target property 36 where needed for proactive wildfire protection; heat-resistant PVC or PET piping 26 shown in FIG. 3H, for forming the necessary fluid pumping circuits passing through the electric pump 22 to operate the sprinkler sprayheads 28 under adequate hydraulic pressure during spraying operations, and thus support sufficient flow rates of Citrotech® fire inhibiting chemical liquid 35, determined in a manner well known in the fluid hydraulic arts; (vii) a 4G GSM/GPRS transceiver and the remote power control switch (e.g. 4G GSM Dual Channel Remote Switch Controller with SMS Command Remote Board with Relay Output and GSM CTL-4G Relay Control Box by Shanghai Wafer Microeletronics Co., Ltd) 24 shown in FIGS. 3C1 and 3C2 for remotely controlling electrical power supplied to the electric-motor hydraulic pump 22 via the 4G GSM remote control power switch 24, automatically triggered when receiving an SMS trigger message/signal 40 from the smartphone 11 operated by a homeowner and/or authorized contractor or other personnel; an optional electrically-powered temperature-controlled thermal blanket 30 for surrounding the storage tank 21, and associated controller 32A for maintaining the temperature of the chemical liquid in the storage tank 21 in extreme temperature climates shown in FIG. 3J, or electrically-powered temperature-controlled immersible heater 33A for maintaining the temperature of the chemical liquid in the storage tank 21 below freezing temperatures in extreme climates shown in FIGS. 3K1 and 3K2.

Preferably, the GPRS/GSM transceiver 24 shown in FIGS. 3C1 and 3C2 is suitably adapted for transmitting and receiving digital data packets using GPRS and GSM communication protocols, over the network, to support a suite of digital communication services and protocols specified herein. Also, a suite of communication services and protocols (e.g. email, SMS alert, PUSH protocol, XML, PDMS, and CALL alert) are supported by GSM for sending and receiving messages. Also, preferably, the electronic wildfire ember and smoke detection module 27 shown in FIGS. 3F1 and 3F2, supports 360 degrees of sensing and associated field of views (FOVs), and in wireless communication with the 4G GSM digital cellular communication network 10.

FIG. 3J shows the two-way flow valve assembly 25 that is used in the illustrative embodiment to control (i) the flow of water from a water source 37 into the electric pump 22 when arranged in its first flow position during sprinkler sprayhead testing operations, and (ii) the flow of Citrotech® liquid fire inhibitor 35 from the storage tank 21 into the electric pump 22 when arranged in its second flow position, and the system is configured for fire inhibitor spraying operations on the property.

In some application environments, ambient temperatures on the property parcel being defended against wildfire may fall below freezing, and in such environments, it will be wise if not necessary to adapt the wildfire defense spraying system to prevent freezing of the liquid fire inhibitor in its storage tank. FIGS. 3K and 3L1 and 3L2 illustrate two different options for controllably heating the liquid fire inhibitor in the storage tank 21 and prevent freezing, and system malfunction, prior to spraying operations are completed on the parcel of property.

FIG. 3K shows an electrically-powered temperature-controlled immersible heating system 31 for immersion in the chemical liquid stored in the storage tank 21 of the wildfire defense spraying system of the present invention 50, when the system is constructed from the kit of system components shown in FIG. 3. The purpose of the heating system is to controllably heat the liquid fire inhibitor 35 in the storage tank 21 using temperature sensor integrated in heating element 33A and controller 33C, as required to prevent freezing and malfunction of the system. Power plug 34E can be directly plugged into a power supply socket 23A supported on the lithium battery power supply unit 23 when powered from 120V AC power service at the installation site (e.g. home).

FIGS. 3L1 and 3L2 show an electrically-powered temperature-controlled heating blanket 32 adapted for wrapping about the storage tank 21 used in the sprinkler-based wildfire defense property spraying system of the present invention 50, when constructed from the kit of system components shown in FIG. 3. The electrically-powered temperature-controller 32A is designed for use with the heating blanket 32 shown in FIG. 3L1, supplying electrical power to the heating elements within the blanket, and monitoring the temperature of the liquid fire inhibitor 35 with a sensor 33B inserted in the storage tank 21, as required to prevent freezing thereof and system malfunction. Power plug 33C can be directly plugged into a power supply socket 23A supported on the lithium battery power supply unit 23 when powered from 120V AC power service at the installation site (e.g. home).

### Specification of the Wireless 4G GSM GPS-Tracked Wildfire Ember and Smoke Detector Used in the Wildfire Defense Spraying System of the Present Invention

FIG. 3F1 shows the wireless 4G GSM GPS-tracked wildfire ember and smoke detection 27 for use as an auxiliary sensor in communication with the wildfire defense spraying systems of the present invention 50. Each wireless GPS-tracked wildfire ember detection module 27 deployed on the 4G GSM digital cellular network 10 comprises: a fire-protective housing cover 27A; and various sensors and signal and data processing and storage components arranged and configured about a microprocessor and flash memory (i.e. control subsystem) include: one or more passive infra-red (PIR) thermal-imaging sensors connected together with suitable IR optics to project IR signal reception field of view (FOV) before the IR receiving array 27B; multiple pyrometric sensors 27C for detecting the spectral radiation of burning, organic substances such as wood, natural gas, gasoline and various plastics; a GPS antenna 27D; a GPS signal receiver; GSM antenna; GSM radio transceiver an Xbee antenna; an Xbee radio transceiver; a voltage regulator; an external power connector; a charge controller; a battery; thermistors; a power switch; external and internal temperature sensors; power and status indicator LEDs; programming ports; a digital/video camera 27G; other environment sensors adapted for collecting and assessing intelligence, in accordance with the spirit of the present invention; and mounting base 27E for mounting on a support bracket that can be affixed to a pole, tree, or building as the case may suggest or require. Alternatively, the wildfire detection module 27, and supporting wireless wildfire intelligence network, may be realized using the technical disclosure of U.S. Pat. No. 8,907,799, incorporated herein by reference. However, the present invention should not be limited by such prior art teachings.

Preferably, the optical bandwidth of the IR sensing arrays 27B used in the thermal sensors will be adequate to perform 360 degrees thermal-activity analysis operations, and automated detection of wildfire and wildfire embers. Specifically, thermal sensing in the range of the sensor can be like the array sensors installed in forward-looking infrared (FLIR) cameras, as well as those of other thermal imaging cameras, use detection of infrared radiation, typically emitted from a heat source (thermal radiation) such as fire, to create an image assembled for video output and other image processing operations to generate signals for use in early fire detection and elimination system of the present invention.

The pyroelectric detectors 27C detect the typical spectral radiation of burning, organic substances such as wood, natural gas, gasoline, and various plastics. To distinguish a flame from the sun or other intense light source such as light emissions from arc welding, and thus exclude a false alarm, the following independent criteria are considered: a typical flame has a flicker frequency of (1 . . . 5) Hz; a hydrocarbon flame produces the combustion gases carbon monoxide (CO) and carbon dioxide (CO₂); and in addition, burning produces water which can also be detected in the infrared range. Each pyroelectric detector 27C is an infrared sensitive optoelectronic component specifically used for detecting electromagnetic radiation in a wavelength range from (2 to 14) μm.

Each system 50 will use a GPS referencing system available in the USA and elsewhere, supporting transmission of GPS signals from a constellation of satellites to the Earth's surface, so that local GPS receivers within the GPS sensor 30 located on each Citrotech® containing storage tank 21, and also each remote wildfire ember and smoke detector 27, will receive the GPS signals and compute locally GPS coordinates indicating the location of the networked device within the GPS referencing system. This GPS location information is then automatically transmitted to a central database server 12 using 4G GSM digital cellular communications, in the preferred embodiment. By managing the GPS location of storage tanks 21, the manufacturer of Citrotech® fire inhibitor can continuously track and map the location of its fire inhibiting chemical liquid around the globe, in relation to the current location of active wildfires, and forecasted risk of wildfire, as part of its supply chain, inventory, and customer service management operations around the world.

When practicing the remote wildfire sensor of the present invention 27, any low power wireless networking protocol of sufficient bandwidth can be used. However, in the preferred embodiment, its 4G GSM digital cellular transceiver circuit will be used to send SMS-based triggering signals 40 directly to its linked wildfire defense spraying system of the present invention 20. Such SMS-based triggering signals 40 will activate its 4G GSM remote power control switch 24, energize the electric pump 22, and spray Citrotech® liquid fire inhibitor 35 all over the property 36 to provide the proactive protection it requires in the presence of a wildfire and its flying embers 41. Such 4G GSM signaling 40 can support SMS between the wireless ember and smoke detector 27, and the one or more linked wildfire defense spraying system(s) 20 that the automated ember detector 27 might be ordered to serve in any given application.

In the illustrative embodiment, the wildfire ember detection system 27 supports a computing platform, network-connectivity (i.e. IP Address), and is provided with native application software installed on the system as client application software, designed to communicate over the system network and cooperate with application server software running on the application servers of the system network, thereby fully enabling the functions and services supported by the system, as described above. In the illustrative embodiment, a wireless mess network may be implemented using conventional IEEE 802.15.4-based networking technologies to interconnect these wireless subsystems into subnetworks and connect these subnetworks to the internet infrastructure of the system of the present invention. However, such wireless 4G GSM wildfire ember and smoke sensor 27 can be used alone with at least one wildfire defense spraying system 50, in which case SMS messaging 40 transmitted to its host WFD spraying system 50 can automatically trigger the 4G GSM controlled spraying system 20 to spray all the Citrotech® liquid fire inhibitor 35 in its storage tank 21, all over the property 36 prior to wildfire arrival for proactive wildfire defense.

### Specification of the Method of Assembling, Installing and Operating the Sprinkler-Based Wildfire Defense Fire Inhibitor Spraying System of the Present Invention

FIGS. 7A, 7B and 7C describe the steps to be undertaken when practicing the preferred method of assembling the components contained in the kit shown in FIG. 3, and thereby installing and operating the sprinkler-based wildfire defense fire inhibitor spraying system of the present invention 50 on a homeowner's property parcel 36, making the kit 20 and method most suitable for do-it-yourself (DYI) home-owner and contractor-assisted installations alike. Typically, it is expected that most installations of the system 50 using the kit of the present invention will requiring between 3-6 hours, following system installation and operating instructions 32 based on the present Patent Specification.

As indicated at Block A in FIG. 7A, the first step involves delivering the Home Wildfire Defense Sprinkler/Spray System (WFDS) Kit 20 to the geographical location where the WFD System 50 is to be installed and operated.

As indicated at Block B in FIG. 7A, the second step involves surveying the property 36 to be defended by spraying fire inhibiting liquid chemistry over combustible surfaces of building and property using a system of sprinklers mounted to building, mounted above property on poles or brackets, and/or from underground installed sprinkler heads as case may be required or desired.

As indicated at Block C in FIG. 7A, the third step involves determining the physical placement location of sprinkler sprayheads 28 to ensure complete spray coverage over and about building structure to be protected by fire inhibitor when sprayed by the installed stationary sprinkler-based fire-protection zone spraying system 50.

As indicated at Block D in FIG. 7A, the fourth step involves confirming that perimeter and surface area of the building structure 36 is covered by overlapping sprinkler spraying patterns with at least 25% (preferably 50%) spray-surface overlapping of sprinkler spray patterns.

As indicated at Block E in FIG. 7A, the fifth step involves mounting and/or installing sprinkler heads on building structure and/or property 36, at the determined placement locations in step c, to achieve the spray coverage required to completely spray property and apply the environmentally clean fire inhibiting coating on all combustible surfaces.

As indicated at Block F in FIG. 7A, the sixth step involves connecting the electrical liquid pump 22, and sprinkler sprayheads 28 in a fluid series configuration using PVC or like plastic tubing 26.

As indicated at Block G in FIG. 7A, the seventh step involves connecting fire inhibitor storage tank 21, and source of water 37, to the electric pump 22 using a valve assembly 25 and PVC or like piping so that either (i) when the 2-way valve assembly 25 which when configured into a first position, water from the water source (e.g. garden hose) is allowed to flow under building water pressure into the electric pump 22 and through the closed fluid pumping loop and spraying from sprinkler heads 28 during testing operations, and (ii) when the valve assembly is configured to a second position, the liquid fire inhibitor 35 premixed and stored in the storage tank 21 is allowed to flow into the electric pump 22 and through the closed pumping loop and spraying from sprinkler heads 28 during proactive wildfire defense spraying operations.

As indicated at Block I in FIG. 7B, the eighth step involves connecting 120V lithium-battery backup power supply system to 120V/30 A service at building location, and then connect 4G GSM remote power control switch between lithium-battery backup power supply system and electric pump, using electrical earth-grounding on the electric fluid (water) pump.

As indicated at Block H in FIG. 7B, the ninth step involves activating (i) the 4G GSM remote power control switch 24 with telecommunication company (e.g. AT&T) providing SIM card for the GSM power control switch 24, which will involve: assigning a phone number and SMS service to the remote power control switch 24, and also (ii) assigning a phone number and SMS service to the 4G GSM GPS sensor 30 mounted on the Citrotech® storage tank 21 at the factory. This will involve activating its 3V battery and enabling the GPS sensor 30 to GPS track the storage tank 21 location and automatically transmit the GPS location data to a SMS server operated by the manufacturer of the wildfire defense spraying system kit 20, and support a GPS tracking and monitoring of each Citrotech® containing storage tank 21 deployed around the globe.

As indicated at Block J in FIG. 7B, the tenth step involves, during sprinkler spray pattern testing operations, configuring the valve assembly 25 into its first flow control position, so that water from a water source (e.g. garden hose or house facet) 37 is allowed to flow under building water pressure into the electric pump 22 and through the closed fluid circulation loop and spraying from sprinkler heads 28, and confirm that the sprinklers 28 are operating property and that their spray coverage and spray patterns are overlapping as desired, and if not, then adjusting the sprinkler heads as needed or otherwise required. As indicated at Block K in FIG. 7B, the eleventh step involves, during activation operations, ascertaining that the adequate amount of Citrotech® wildfire inhibitor dry powder 29 is contained in the storage tank 21 (to the dry powder fill line), and then fasten mixing nozzle 27 to hose and fill the storage tank 21 with water 37 to its water fill line so that premixed Citrotech® liquid wildfire inhibitor 35 will be ready for spray application once the proper quantity of water has been added to the storage tank 21.

As indicated at Block L in FIG. 7B, the twelfth step involves configuring the Valve Assembly to the Second Position, so that the premixed Citrotech® liquid wildfire inhibitor 35 is premixed and stored in the storage tank 21 is allowed and to flow into the electric pump 22 and be driven through the closed irrigation loop and spraying from sprinkler heads 28, under the pressure of the electric pump 22 in the fluid loop during proactive wildfire defense spraying operations.

As indicated at Block M in FIG. 7C, the thirteenth step involves registering the installed and configured WFD spraying system 50 with Mighty Fire Breaker, LLC by (i) browsing to the Site http://www.mightyfirebreaker.com/citrotech-locked-n-loaded, (ii) scanning the unique QR code (or RFID tag or other machine-readable code) 31 assigned to and located on the Citrotech® liquid chemical storage tank 21, and (iii) completing the Registration Process, using the GPS-tracking information collected from the WFD spraying system 50; an email notification will be sent to user once Registration Process is completed.

As indicated at Block N in FIG. 7C, the fourteenth step involves, prior to arrival of a wildfire at the building location, and just prior to proactive wildfire defense spraying operations, the homeowner or authorized personnel using a mobile smartphone 11 or other phone device to send a SMS activation signal 40 over the digital cellular network to the 4G GSM remote power control switch 24 at the property location, so as that electrical power is automatically delivered to the electric pump 22 from the backup batter storage system 23 and enables the electric pump 22 to work and start pumping the premixed Citrotech® liquid wildfire from the storage tank 21 through the closed pumping loop and spraying out from sprinkler heads 28, under the fluid loop pressure, to provide all combustible surfaces on the property including the building 36, with a Citrotech® environmentally-clean potassium salt crystalline coating—that protects the combustible material from fire ignition, flame spread and smoke development when encountering hot flying wildfire embers during a wildfire storm.

As indicated at Block O in FIG. 7C, the fifteenth step involves any time after discharge and spraying of the Citrotech® fire inhibiting liquid 35 from the storage tank 21, and/or after the safe passage of a wildfire at the building location with all mitigated damages repaired, reactivating, and preparing the wildfire defense spraying system 50 for its next round of proactive fire defense spraying operations, as follows:
(i) Configuring the valve assembly 25 in the First Position and then flush all sprinkler heads with clean water for 10 minutes, according to Step J;
(ii) Configuring the value assembly 25 in the Second Position, and then refill the storage tank 21 with a new Citrotech® dry powder fire inhibitor cartridge (e.g. 25 lbs.) 29 from its manufacturer, and then fill the storage tank 21 to the Water Fill Line using clean water supplied through the mixing nozzle 27 as described in Step K; and
(iii) Configuring the valve assembly 25 to its Second Position and prepare and configure the WFD System 50 as loaded and ready for the next wildfire threat (i.e. the system is loaded and ready to spray upon being triggered).

As indicated at Block P in FIG. 7C, the thirteenth step involves triggering the WFD system after any significant rainfall on the property which may have dissolved, washed away, or deteriorated the Citrotech® potassium salt crystalline coatings, which once proactively protected combustible materials on the property from fire ignition, flame spread and smoke development.

At this juncture it will be appropriate to describe three topologically different kinds of clean-chemistry wildfire breaks and protection-zones that might be proactively formed about, before, or over targeted properties, using the wireless remotely activated wildfire defense spraying system, with respect to prevailing winds in the environment under consideration.

### Specification of an Above-Ground Sprinkler-Based Firebreak Spray System Installation Mounted on a Building and Property to be Defended Against Wildfire

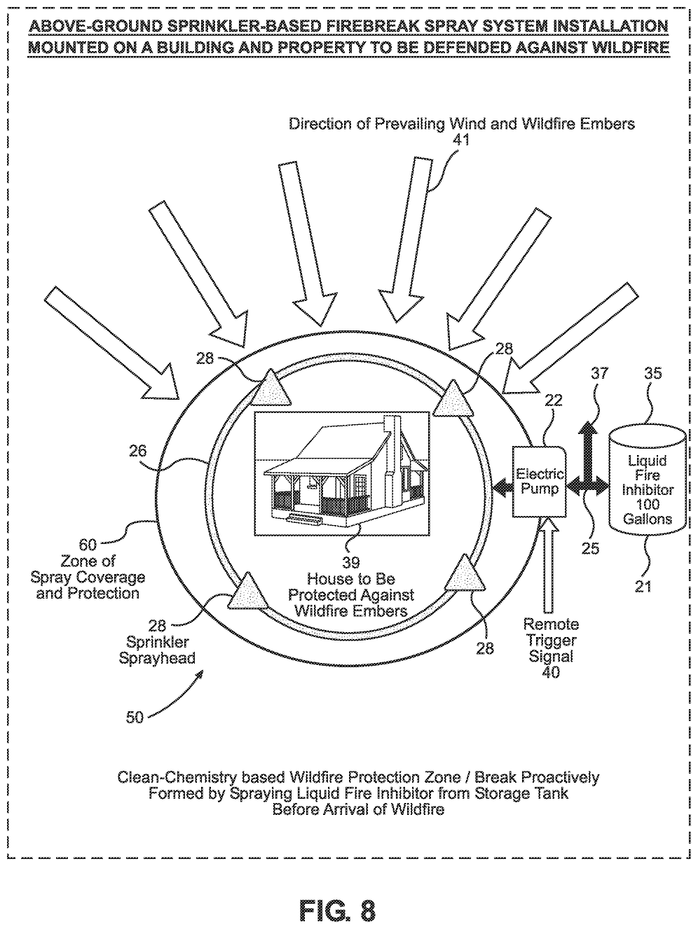

FIG. 8 shows an above-ground sprinkler-based firebreak spray system installation 50 of the present invention mounted on a building and property to spray the region with an environmentally-clear liquid fire inhibitor for defending against wildfire by inhibiting fire ignition and flame spread by hot flying wildfire embers created during a wildfire storm. During operation, the system proactively forms a clean-chemistry based wildfire protection zone/break 60 over and about a house/property to be protected/defended by spraying liquid fire inhibitor 35 from storage tank 21 before arrival of wildfire.

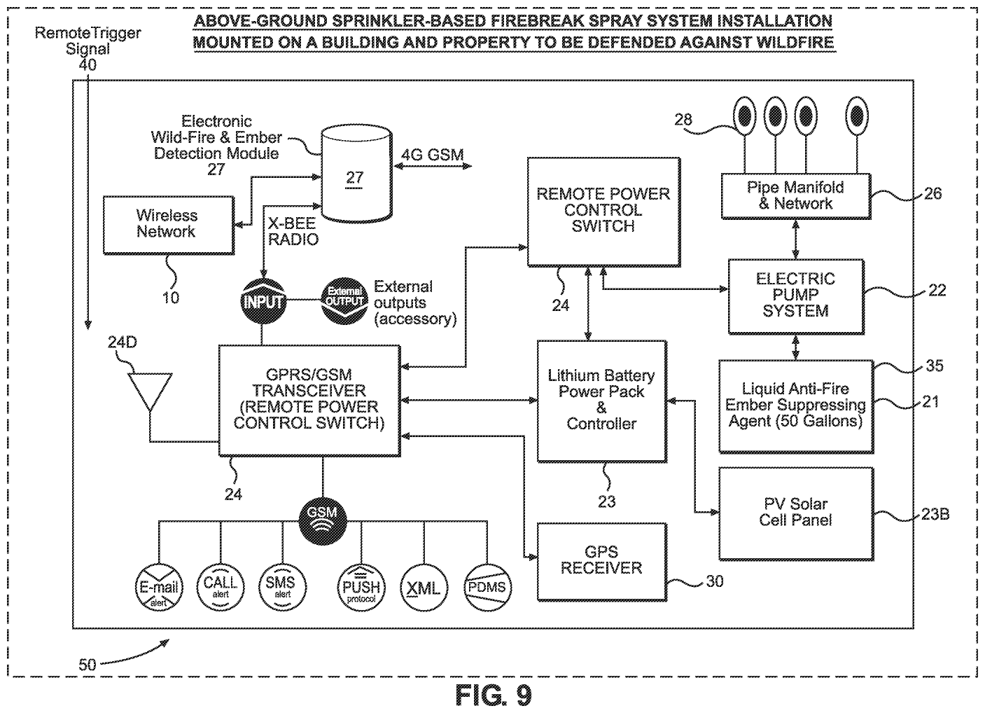

FIG. 9 shows the wireless remotely-activatable sprinkler-based wildfire defense fire inhibitor spraying system of the present invention 50 deployed in FIG. 8, which is modeled after the general system shown in FIG. 6 and described above.

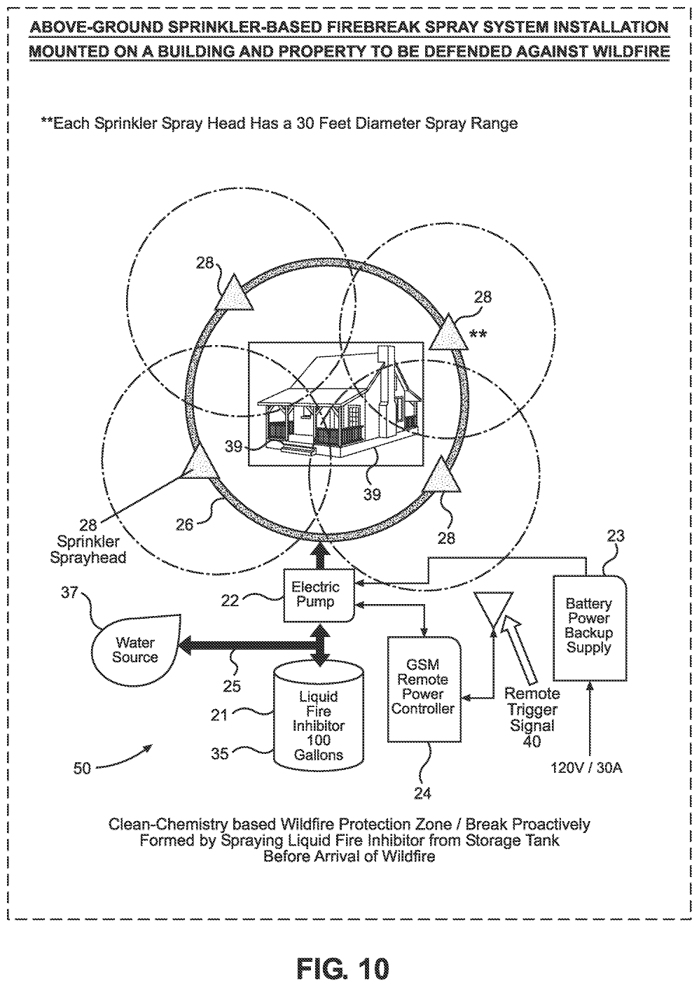

FIG. 10 is a schematic diagram shows the spray patterns generated by the sprinkler heads 28 mounted about the building, and driven by the wildfire defense fire inhibiting spraying system 50 of this illustrative embodiment of the present invention.

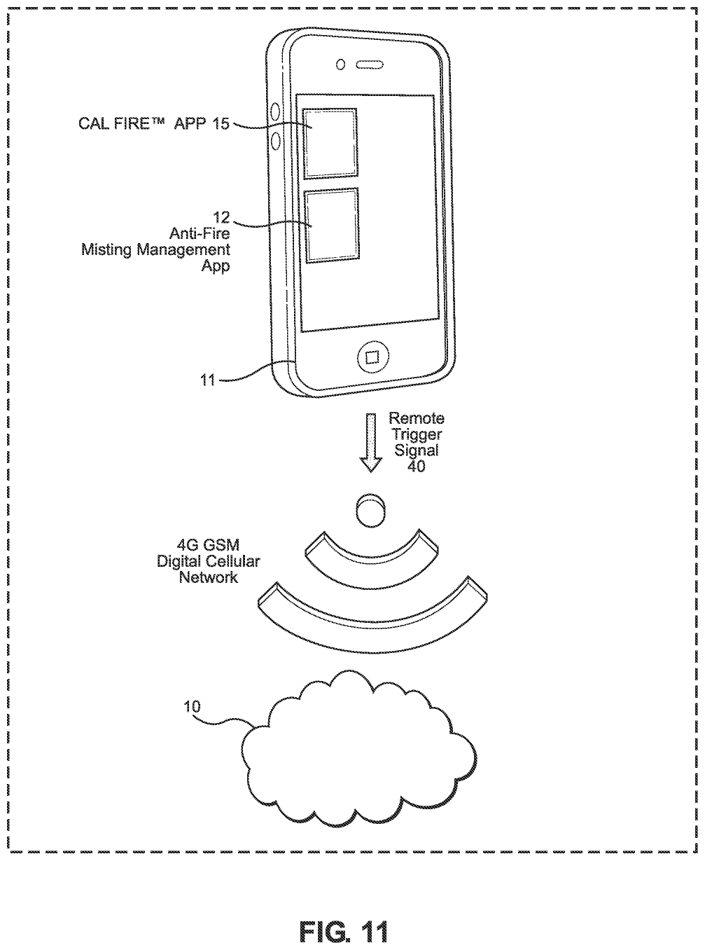

FIG. 11 shows mobile smartphone 11 being used to remotely activate the spraying of Citrotech® fire inhibitor before the arrival of a wildfire on the property of the system installation 50 of FIGS. 9 and 10, using SMS supported by a 4G GSM digital cellular communication link between the smartphone 11 and the 4G GSM remote power control switch 24 employed at the spraying system installation. Specifically, the homeowner sends a text message 40 via SMS over 4G GSM digital cellular network to automatically activate electric pump 22 via the 4G GSM remote power control switch 24 used in the wildfire defense spraying system 50. When the pump 21 completes pumping and spraying all the fire inhibitor 35 in the storage tank 21, the electric pump will automatically shut off, and water molecules in the liquid fire inhibitor will begin to immediately evaporate forming fire-inhibiting potassium salt crystalline coatings on sprayed property.

### Specification of an Above-Ground Sprinkler-Based Firebreak Spray System Installation Mounted on a Building and Property to be Defended Against Wildfire

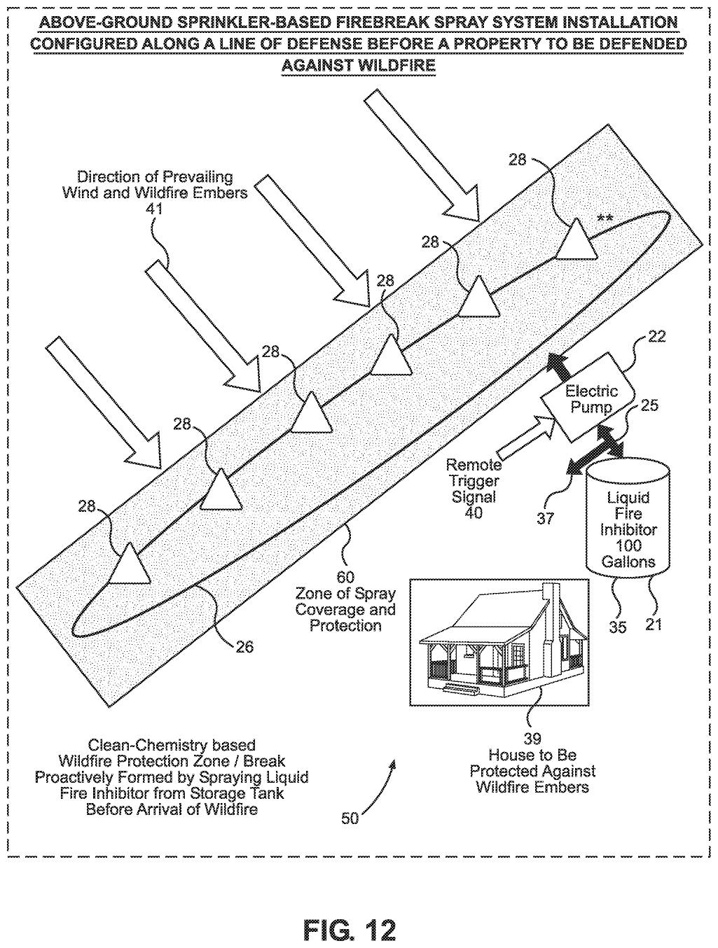

FIG. 12 shows an above-ground sprinkler-based firebreak spray system installation of the present invention 50 configured before a property and building 36 to be defended against wildfire by spraying a zone of fire inhibiting chemistry 60 that inhibits fire ignition and flame spread by hot flying wildfire embers created during a wildfire storm 41.

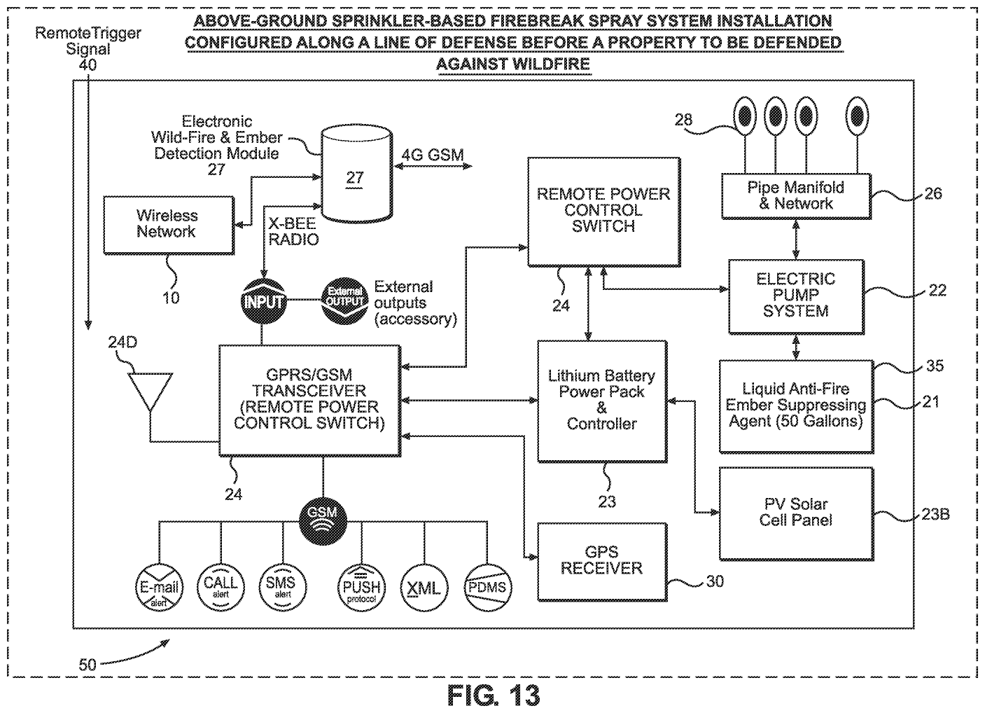

FIG. 13 shows a wireless remotely-activatable sprinkler-based wildfire defense fire inhibitor spraying system of the present invention 50 deployed in FIG. 12, which is modeled after the general system shown in FIG. 6 and described above.

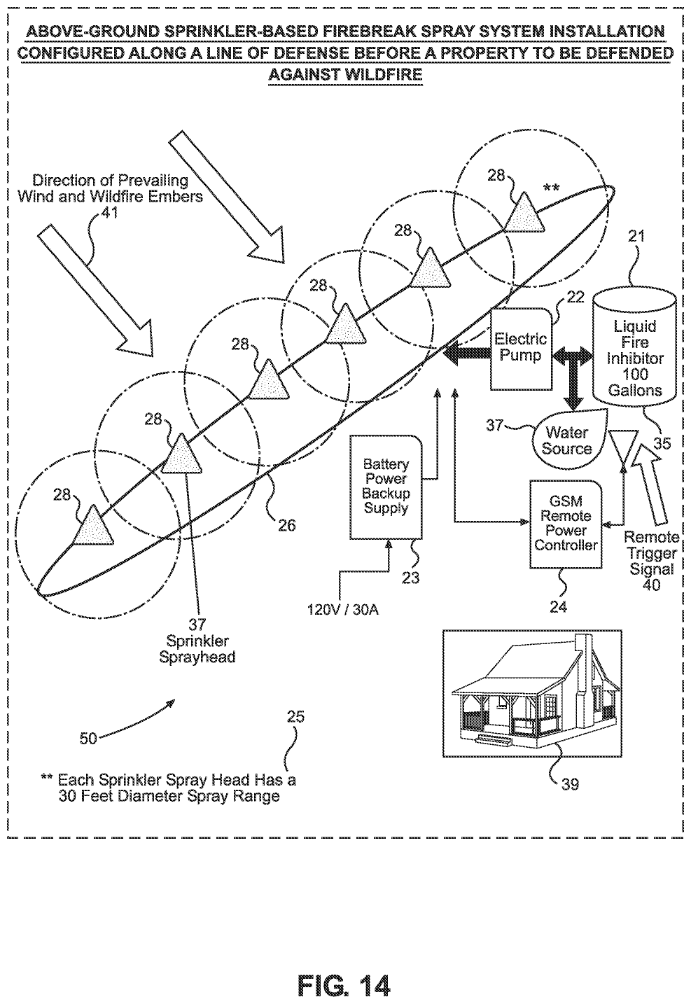

FIG. 14 shows the resulting linear spray pattern generated by the sprinkler heads 28 mounted above the ground before the property to be protected and driven by the wildfire defense fire inhibiting spraying system 50 of this illustrative embodiment of the present invention.

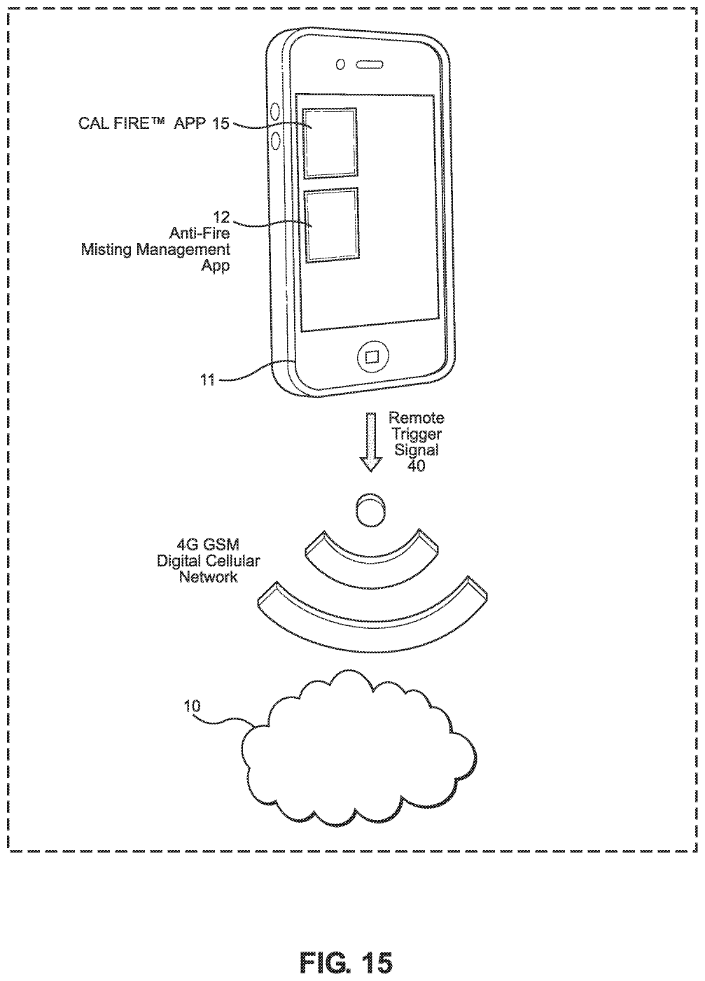

FIG. 15 shows a mobile smartphone 11 being used to remotely activate the spraying of fire inhibitor 35 before the arrival of a wildfire on the property of the system installation 50 of FIGS. 13 and 14, using SMS supported by a 4G GSM digital cellular communication link between the smartphone 11 and the 4G GSM remote power control switch 24 employed at the spraying system installation. Specifically, the homeowner sends a text message 40 via SMS over 4G GSM digital cellular network to automatically activate electric pump 22 via the 4G GSM remote power control switch 24 used in the wildfire defense spraying system. When the pump 21 completes pumping and spraying all the fire inhibitor 35 in the storage tank 21, the electric pump will automatically shut off, and water molecules in the liquid fire inhibitor will begin to immediately evaporate forming fire-inhibiting potassium salt crystalline coatings on sprayed property.

Specification of Underground Sprinkler-Based Fire-Zone Spray System Installation Configured about a Property to be Defended Against Wildfire

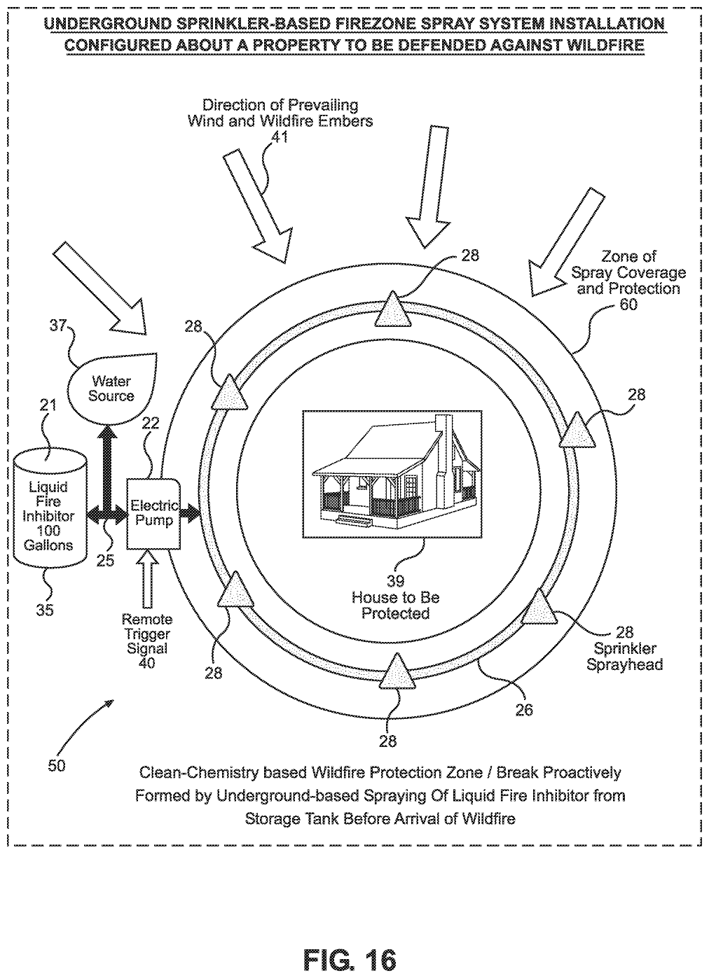

FIG. 16 shows an under-ground sprinkler-based firebreak spray system installation of the present invention 50 configured about a property to be defended against wildfire by spraying a zone of fire inhibiting chemistry 60 that inhibits fire ignition and flame spread by hot flying wildfire embers 41 created during a wildfire storm.

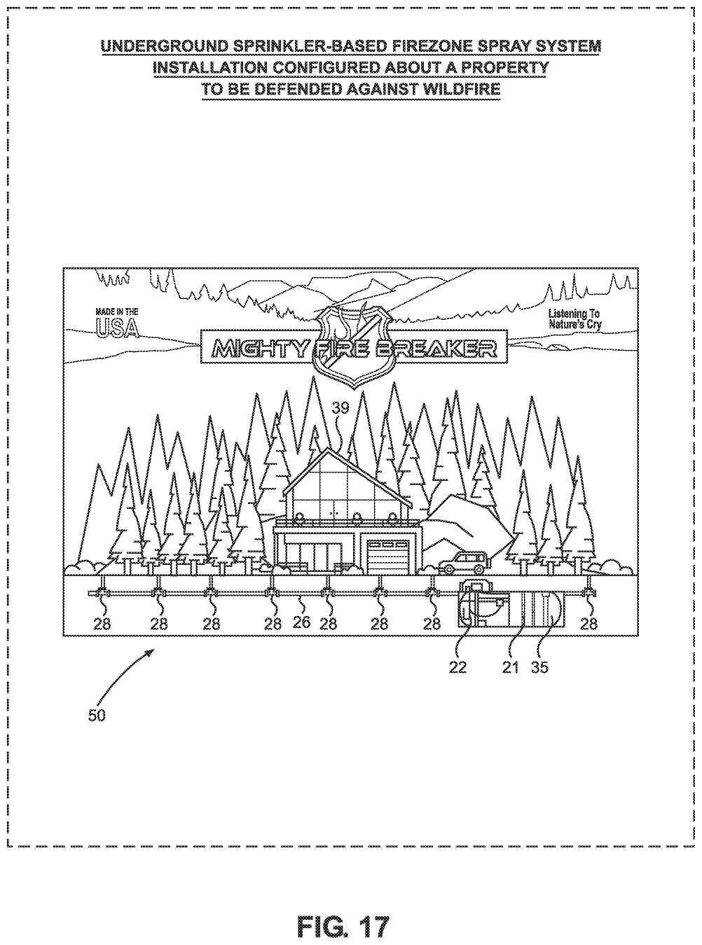

FIG. 17 shows the wireless remotely-activatable sprinkler-based wildfire defense fire inhibitor spraying system of the present invention 50 deployed in FIG. 16.

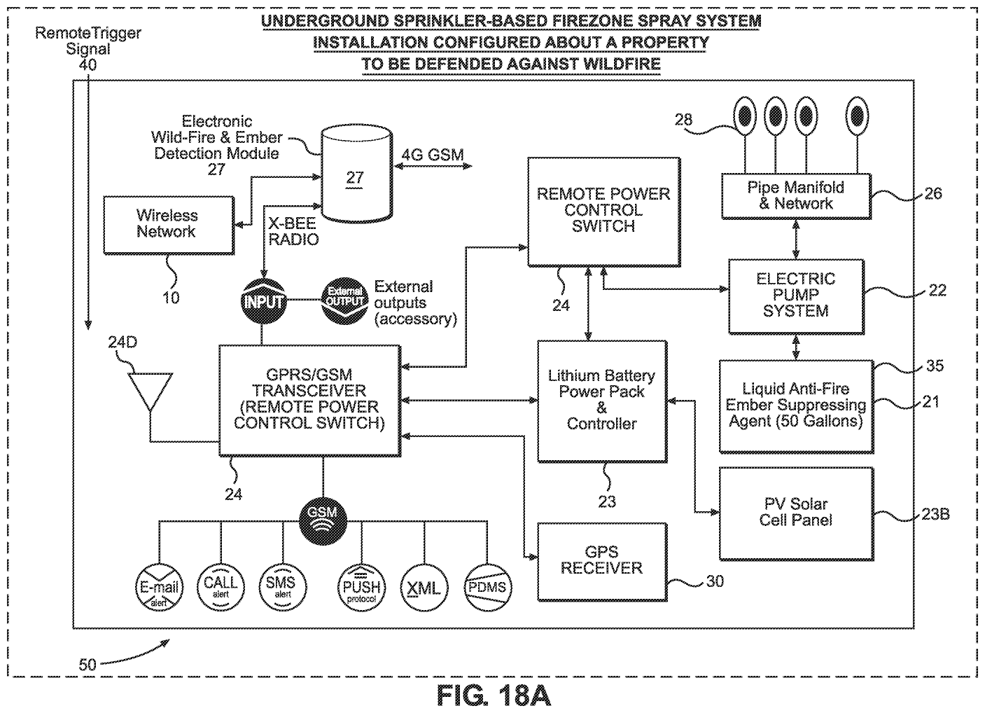

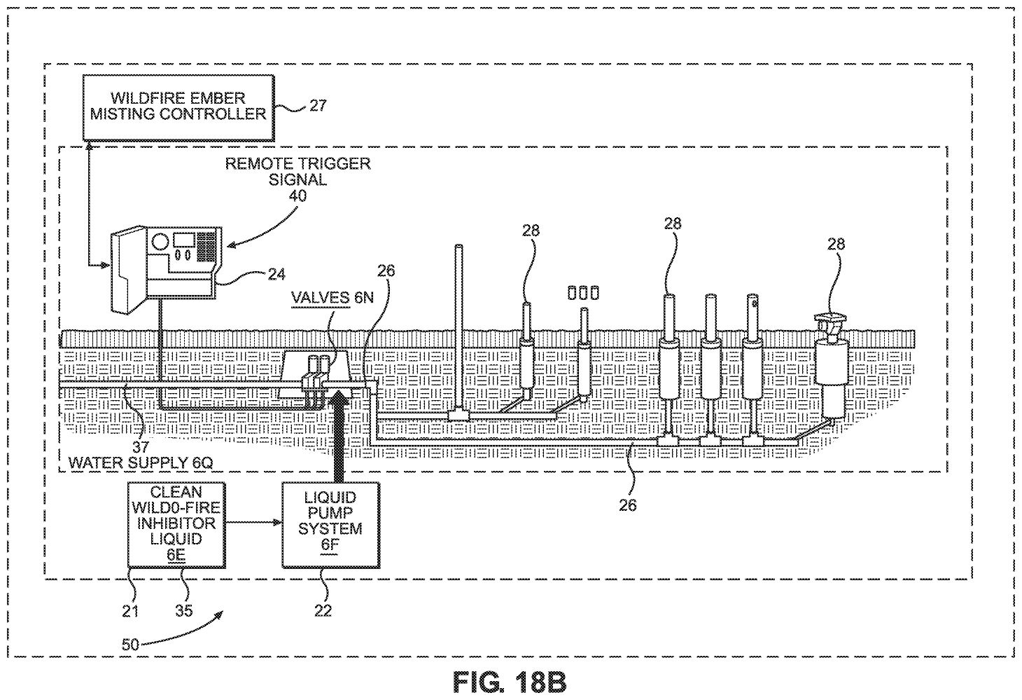

FIG. 18A shows the system of the present invention depicted in FIGS. 16 and 17, which is modeled after the general system shown in FIG. 6 and described above.

FIG. 18B shows that the spray heads 28, chemical storage tank 21 and electric pump 22 and components are mounted underground, and configured for automatically spraying preconfigured patterns of environmentally-clean fire inhibitor on ground surfaces requiring proactive protection against wildfires.

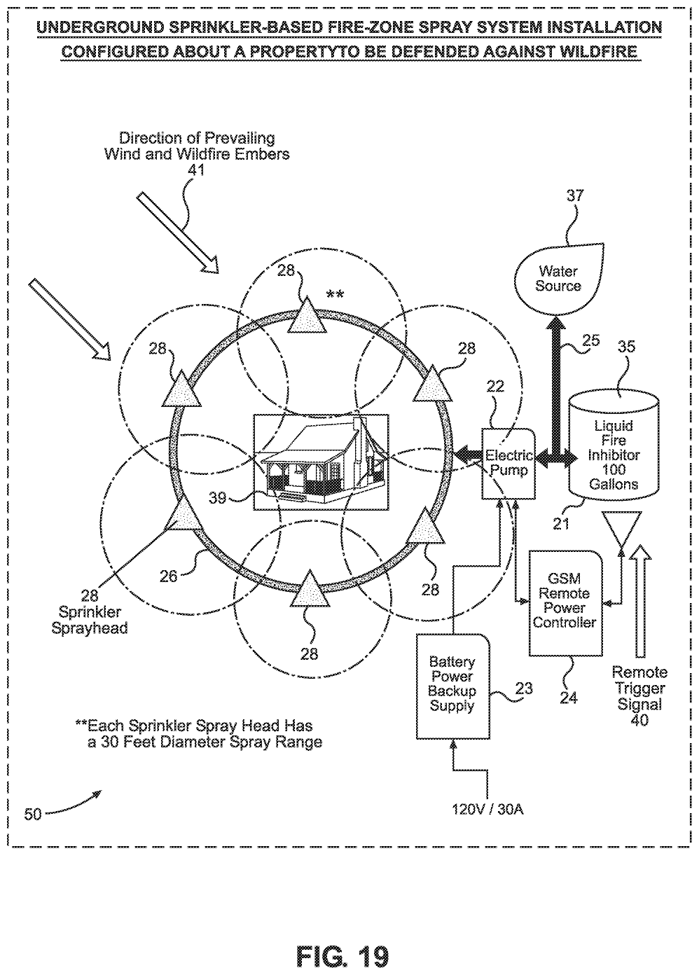

FIG. 19 shows the resulting linear spray pattern generated by the sprinkler heads 28 mounted underground before and/or about the property to be protected, and driven by the wildfire defense fire inhibiting spraying system of this illustrative embodiment 50 of the present invention.

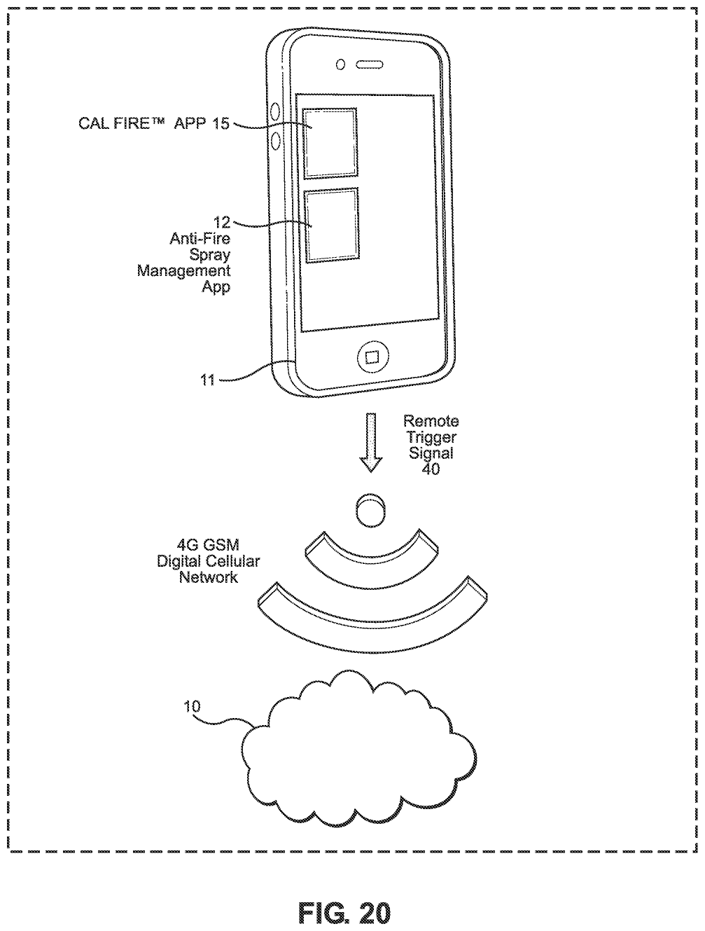

FIG. 20 shows a mobile smartphone 11 being used to remotely activate the spraying of fire inhibitor 35 before the arrival of a wildfire on the property of the system installation of FIGS. 18A, 18B and 19, using SMS supported by a 4G GSM digital cellular communication link between the smartphone 11 and the 4G GSM remote power control switch 24 employed at the spraying system installation 50. Specifically, the homeowner sends a text message via SMS over 4G GSM digital cellular network to automatically activate electric pump 21 via the 4G GSM remote power control switch 24 used in the wildfire defense spraying system 50. Specifically, the homeowner sends a text message 40 via SMS over 4G GSM digital cellular network to automatically activate electric pump 22 via the 4G GSM remote power control switch 24 used in the wildfire defense spraying system. 50 When the pump 21 completes pumping and spraying all the fire inhibitor 35 in the storage tank 21, the electric pump 22 will automatically shut off, and water molecules in the liquid fire inhibitor will begin to immediate evaporate forming fire-inhibiting potassium salt crystalline coatings on sprayed property 36.

### Method of Operating the Wildfire Defense Spraying System of the Present Invention

In the preferred embodiments described above, a building/home owner or manager can manually activate and operate the spraying system from anywhere to protect either the building and/or ground surfaces around the building, as desired or required, based on intelligence in the possession of the human operator or manager.

Alternatively, the automated wildfire ember controller 27 when activated, in cooperation with the local electronic wildfire and ember detection module 27 and associated 4G GSM cellular network, automatically activates and operates the electric pump of the spraying system to protect both the building and/or ground surfaces around the building, as required, based on intelligence automatically collected by ember/smoke detector deployed on the wireless network and linked to the homeowner's wildfire defense spraying system.

Preferably, each wildfire defense spraying system 50 will include automated mechanisms for remotely monitoring and reporting the amount of Citrotech® fire inhibitor chemical liquid available and remaining for use in supporting spraying operations. Such monitoring will help to ensure that adequate reserves of fire inhibiting chemical liquid are stored in GPS-tracked storage tanks 21 on each property before any given wildfire strike to support wildfire ember suppression spraying operations.

Typically, the locked and loaded home wildfire defense system will be manually triggered by the owners several hours and just before the owners are required to evacuate their homes and property for safety reasons, by authorities such as the local fire chief and deputies. Alternatively, the wildfire home defense system can also be remotely triggered using a mobile smartphone 11, if required, with the property owners not home to manually triggering the spraying defense mode of the system.

The system will be remotely controllable by the building manger/home-owner using a mobile computing system 11 running the mobile application. Suitable graphical user interfaces (GUIs) can be supported on the mobile application to enable the user to monitor and control the system locally, or from a remote location, in real-time, provided the wireless communication infrastructure is not disrupted by a wildfire. In the case of active wildfires, a wildfire detection and notification network can be provided for continuously collecting, recording and monitor intelligence about specific regions of land and any wildfires detected in such regions, and advise any specific home/building owner of the status of any specific building before, during and after a wildfire.

### MODIFICATIONS TO THE PRESENT INVENTION WHICH READILY COME TO MIND

The illustrative kits and spray system embodiments disclose using environmentally clean fire inhibiting biochemical compositions of matter developed by Applicant and covered under pending U.S. patent application Ser. No. 17/167,084 filed Feb. 4, 2021, and titled ENVIRONMENTALLY-CLEAN WATER-BASED FIRE INHIBITING BIOCHEMICAL COMPOSITIONS, AND METHODS OF AND APPARATUS FOR APPLYING THE SAME TO PROTECT PROPERTY AGAINST WILDFIRE, incorporated herein by reference. However, it is understood that alternative clean fire inhibiting chemical compositions may be used to practice the wild fire defense methods according to the principles of the present invention.

In the illustrative embodiment of the wildfire home defense spraying system of the present invention, 4G GSM digital cellular communications is provided between the electrical pump components of the system and the homeowner's smartphone, enabling the remote triggering of automated fire inhibitor spraying operations on the property in response to a single SMS text message sent over the network from the homeowner's smartphone. This is a very reliable method of remote triggering because electrical power and internet service failure at homes during an active wildfire is more likely than loss of digital cellular service, all things considered.

However, it is understood that a web-based remote-control method for triggering the spraying system can be practiced as well by using a mobile application running a native mobile application or web browser application, and an Internet-based remote electrical power controller installed aboard the wildfire defense spraying system. Notably, in such a web-based alternative embodiment of the present invention, Internet service (and WIFI Service) will be required at the home-based property being protected, in order to enable remote-triggering of spraying operations executed using the homeowner's mobile smartphone running the native mobile application or web browser application, as the case may be.

All things considered, the 4G GSM remote control method would appear more reliable in most applications. However, in some applications, the web-based application might seem preferred. Also, in yet other environments and applications, use of both 4G GSM and web-based methods might be preferred to provide the homeowners two options of remote-control triggering of fire inhibitor spraying operations on a particular GPS-specified parcel of property.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

What is claimed is:

1. A wildfire defense spraying system installed on property with combustible surfaces and adapted for spraying the property with an environmentally-clean water-based liquid fire inhibitor for defending against wildfire by inhibiting fire ignition and flame spread caused by hot flying wildfire embers created during a wildfire storm, said wildfire defense spraying system comprises:
a storage tank for containing a supply of environmentally-clean water-based liquid fire inhibitor comprising a major amount of an alkali metal salt of a nonpolymeric carboxylic acid, and a minor amount of triethyl citrate (TEC) dissolved in a major amount of water according to a prespecified formulation, wherein said environmentally-clean water-based liquid fire inhibitor remains stable without the formation of solids at expected operating temperatures, and ready for immediate spraying on combustible surfaces;
an electric-powered hydraulic pump system connected to power control switch employed to supply electrical power from a power source to said electric-powered hydraulic pump system; and
a plurality of spray heads mounted about said building and on the property, in fluid communication with said storage tank, and driven by said electric-powered hydraulic pump system;
wherein during operation, said electric-powered hydraulic pump system pumps said environmentally-clean water-based liquid fire inhibitor from said storage tank and through said spray heads to produce a spray pattern of environmentally-clean water-based liquid fire inhibitor all over combustible surfaces on the property, and as water molecules in the sprayed environmentally-clean water-based liquid fire inhibitor evaporate to the environment, thin fire-inhibiting alkali metal salt crystalline coatings form on the combustible surfaces, inhibiting fire ignition and flame spread in the presence of wildfire embers.

2. The wildfire defense spraying system of claim 1, wherein said power source comprises a battery power supply source.

3. The wildfire defense spraying system of claim 1, wherein said alkali metal salt of a nonpolymeric carboxylic acid comprises tripotassium citrate (TPC).

4. The wildfire defense spraying system of claim 1, wherein said spray pattern comprises a linear spray pattern generated by said spray heads mounted on the property to form a clean-chemical wildfire break against any incidence wildfire storm.

5. The wildfire defense spraying system of claim 1, wherein said spray pattern comprises a resulting spray pattern encircling the property generated by said spray heads mounted on the property to form a clean-chemical wildfire protection zone against any incidence wildfire storm.

6. The wildfire defense spraying system of claim 1, wherein said expected operating temperatures extend over a range from about 34 F to about 120 F.

7. A wildfire defense spraying system installed on property with combustible surfaces comprising:
a storage tank for containing a supply of environmentally-clean water-based liquid fire inhibitor comprising a major amount of an alkali metal salt of a nonpolymeric carboxylic acid, and a minor amount of triethyl citrate (TEC) dissolved in a major amount of water according to a prespecified formulation, wherein said environmentally-clean water-based liquid fire inhibitor remains stable without the formation of solids at expected operating temperatures, and ready for immediate spraying on combustible surfaces;
fluid pumping loop having a hydraulic pump system connected to a plurality of spray heads and said storage tank;
wherein, during operation, said hydraulic pump system automatically pumps said environmentally-clean water-based liquid fire inhibitor from said storage tank and through one or more spray heads to produce a spray pattern of environmentally-clean water-based liquid fire inhibitor all over combustible surfaces on the property, and as water molecules in the sprayed environmentally-clean water-based liquid fire inhibitor evaporate to the environment, thin fire-inhibiting alkali metal salt crystalline coatings form on the combustible surfaces, inhibiting fire ignition and flame spread in the presence of wildfire embers.

8. The wildfire defense spraying system of claim 7, wherein said alkali metal salt of a nonpolymeric carboxylic acid comprises tripotassium citrate (TPC).

9. The wildfire defense spraying system of claim 7, wherein said spray pattern comprises a linear spray pattern generated by said spray heads mounted on the property to form a clean-chemical wildfire break against any incidence wildfire storm.

10. The wildfire defense spraying system of claim 7, wherein said spray pattern comprises a resulting spray pattern encircling the property generated by said spray heads mounted on the property to form a clean-chemical wildfire protection zone against any incidence wildfire storm.

11. The wildfire defense spraying system of claim 7 wherein said expected operating temperatures extend over a range from about 34 F to about 120 F.

12. A wildfire defense spraying system installed on property with combustible surfaces, comprising:
a storage tank for containing a supply of environmentally-clean water-based liquid fire inhibitor comprising a major amount of an alkali metal salt of a nonpolymeric carboxylic acid, and a minor amount of triethyl citrate (TEC) dissolved in a major amount of water according to a prespecified formulation, wherein said environmentally-clean water-based liquid fire inhibitor remains stable without the formation of solids at expected operating temperatures, and ready for immediate spraying on combustible surfaces;
a GPS sensor for mounting to said storage tank for monitoring the GPS location thereof;
an electric hydraulic pump system connected to said storage tank;
a battery power supply system for supplying electrical power to said electric hydraulic pump system; and
one or more spray heads, and piping for forming a fluid pumping circuit on said property, including said electric hydraulic pump system to one or more spray heads located along said fluid pumping circuit;
wherein, during operation, said electric hydraulic pump system automatically pumps said environmentally-clean water-based liquid fire inhibitor from said storage tank and through said spray heads to produce a spray pattern of environmentally-clean water-based liquid fire inhibitor all over the combustible surfaces on the property, and as water molecules in the sprayed environmentally-clean water-based liquid fire inhibitor evaporate to the environment, thin fire-inhibiting alkali metal salt crystalline coatings form on the combustible surfaces, inhibiting fire ignition and flame spread in the presence of wildfire embers.

13. The wildfire defense spraying system of claim 12, wherein said alkali metal salt of a nonpolymeric carboxylic acid comprises tripotassium citrate (TPC).

14. The wildfire defense spraying system of claim 12, wherein said spray pattern comprises a linear spray pattern generated by said spray heads mounted on the property to form a clean-chemical wildfire break against any incidence wildfire storm.

15. The wildfire defense spraying system of claim 12, wherein said spray pattern comprises a resulting spray pattern encircling the property generated by said spray heads mounted on the property to form a clean-chemical wildfire protection zone against any incidence wildfire storm.

16. The wildfire defense spraying system of claim 12, wherein said expected operating temperatures extend over a range from about 34 F to about 120 F.

17. A wildfire defense spraying system installed on property with combustible surfaces and adapted to spray the property with an environmentally-clean liquid fire inhibitor for defending against wildfire by inhibiting fire ignition and flame spread by hot flying wildfire embers created during a wildfire storm, said wildfire defense spraying system comprising:
a storage tank for containing a supply of environmentally-clean water-based liquid fire inhibitor comprising a major amount of an alkali metal salt of a nonpolymeric carboxylic acid, and a minor amount of triethyl citrate (TEC) dissolved in a major amount of water according to a prespecified formulation, wherein said environmentally-clean water-based liquid fire inhibitor remains stable without the formation of solids at expected operating temperatures, and ready for immediate spraying on combustible surfaces; and
a fluid pumping loop having a hydraulic pump system operably connected to said storage tank and a plurality of spray heads;
wherein, during operation, said hydraulic pump system automatically pumps said environmentally-clean water-based liquid fire inhibitor from said storage tank and through said spray heads to produce a spray pattern of environmentally-clean water-based liquid fire inhibitor all over the combustible surfaces on the property, and as water molecules in the sprayed environmentally-clean water-based liquid fire inhibitor evaporate to the environment, thin fire-inhibiting alkali metal salt crystalline coatings form on the combustible surfaces, inhibiting fire ignition and flame spread in the presence of wildfire embers.

18. The wildfire defense spraying system of claim 17, wherein said alkali metal salt of a nonpolymeric carboxylic acid comprises tripotassium citrate (TPC).

19. The wildfire defense spraying system of claim 17, wherein said spray pattern comprises a linear spray pattern generated by said spray heads mounted on the property to form a clean-chemical wildfire break against any incidence wildfire storm.

20. The wildfire defense spraying system of claim 17, wherein said spray pattern comprises a resulting spray pattern encircling the property generated by said spray heads mounted on the property to form a clean-chemical wildfire protection zone against any incidence wildfire storm.

21. The wildfire defense spraying system of claim 17, wherein said expected operating temperatures extend over a range from about 34 F to about 120 F.
